(19) United States
(12) Patent Application Publication
(10) Pub. No.: US 2026/0270384 A1
(43) Pub. Date: Sep. 10, 2026

(54) ANGLE ADJUSTMENT MODULE AND PROJECTION DEVICE

(71) Applicant: Coretronic Corporation, Hsin-Chu (TW)

(72) Inventors: Kuang-Hsiang CHANG, Hsin-Chu (TW); Cheng-Kuei CHEN, Hsin-Chu (TW); Pei-Cheng LIAO, Hsin-Chu (TW)

(73) Assignee: Coretronic Corporation, Hsin-Chu (TW)

(21) Appl. No.: 19/558,463

(22) Filed: Mar. 6, 2026

(30) Foreign Application Priority Data
Mar. 10, 2025 (CN) 2025102749323

(51) Int. Cl. H04N 13/327; H04N 13/194; H04N 13/207; H04N 13/363; H04N 13/398

(52) U.S. Cl. CPC H04N 13/327; H04N 13/194; H04N 13/207; H04N 13/363; H04N 13/398

(57) ABSTRACT

An angle adjustment module is applicable to a projection device and includes a driving device and an elevating device including a linkage support assembly in the projection device and an elevating assembly. The driving device in the projection device includes a driving assembly on a bottom cover of the projection device and a transmission assembly connected to the driving assembly. The elevating assembly passes through an opening of the bottom cover of the projection device. The linkage support assembly is connected to one end of the elevating assembly in the projection device and the transmission assembly to drive the elevating assembly to move relative to the bottom cover to adjust a pitch angle of the projection device and provide a static support force for the elevating assembly. Therefore, the pitch angle of the projection device can be adjusted by the driving assembly without manually lifting the projection device.

### CROSS REFERENCE TO RELATED PRESENT DISCLOSURE

This application claims the priority benefit of Chinese Patent Application Serial Number 2025102749323, filed on Mar. 10, 2025, the entire content of which is hereby incorporated by reference herein.

### TECHNICAL FIELD

The present invention relates to an angle adjustment module and a projection device, and in particular to an angle adjustment module capable of adjusting a pitch angle of a projection device using driving power and a projection device using the angle adjustment module.

### RELATED ART

The bottom of a projection device is usually provided with a lifting foot pad, and a user can manually adjust the height of the lifting foot pad to change a projecting angle of a projection image to meet the projection needs of the user.

For a relatively heavy projection device, the weight of the projection device directly presses against the lifting foot pad, making it more difficult for the user to manually adjust the lifting foot pad. In addition, a rotating type lifting foot pad is usually directly screwed into the bottom of the projection device from the outside, so the user may inadvertently screw out the rotating type lifting foot pad from the bottom of the projection device without being aware, thereby causing the rotating lifting foot pad to fall off. Moreover, a pop-up type lifting foot pad cannot meet the fine-tuning requirements because the amount of its pop-up is difficult for the user to manually control precisely, and an additional release button needs to be designed in the structure for the user to press and release the pop-up type lifting foot pad.

Therefore, in existing projection devices, a design for manually adjusting the height of the lifting foot pad may result in inconvenient user operation or poor efficiency in adjusting the pitch angle of the projection device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The embodiments of the present invention provide an angle adjustment module and a projection device, which can solve the problems of inconvenient user operation or poor efficiency in adjusting the pitch angle of the projection device in existing designs that rely on manually adjusting the height of the lifting foot pad.

Other purposes and advantages of the invention can be further understood from the technical features disclosed in the invention.

In order to achieve one or part or all of the above objectives or other objectives, an embodiment of the present invention proposes an angle adjustment module, which is applicable to a projection device which comprises a bottom cover with an opening. The angle adjustment module includes a driving device and an elevating device, the driving device is disposed in the projection device, the driving device includes a driving assembly and a transmission assembly, and the elevating device includes a linkage support assembly and an elevating assembly. The driving assembly is disposed on the bottom cover, and one end of the transmission assembly is connected to the driving assembly. The elevating assembly passes through the opening of the bottom cover and moves relative to the bottom cover in a direction perpendicular to the bottom cover to adjust a pitch angle of the projection device. The linkage support assembly is disposed in the projection device, and the linkage support assembly is respectively connected to one end of the elevating assembly located in the projection device and the other end of the transmission assembly to drive the elevating assembly to move relative to the bottom cover and provide a static support force for the elevating assembly.

In order to achieve one or part or all of the above objectives or other objectives, an embodiment of the present invention proposes a projection device including a bottom cover and an angle adjustment module. The bottom cover is provided with an opening, and the angle adjustment module includes a driving device and an elevating device. The driving device is disposed in the projection device, the driving device includes a driving assembly and a transmission assembly, and the elevating device includes a linkage support assembly and an elevating assembly. The driving assembly is disposed on the bottom cover, and one end of the transmission assembly is connected to the driving assembly. The elevating assembly passes through the opening of the bottom cover and moves relative to the bottom cover in a direction perpendicular to the bottom cover to adjust a pitch angle of the projection device. The linkage support assembly is disposed in the projection device, and the linkage support assembly is respectively connected to one end of the elevating assembly located in the projection device and the other end of the transmission assembly to drive the elevating assembly to move relative to the bottom cover and provide a static support force for the elevating assembly.

Based on the above, the embodiments of the present invention have at least one of the following advantages or effects. In the design of the angle adjustment module and the projection device of the present embodiments, the transmission assembly is driven by the driving assembly, so that the transmission assembly drives the linkage support assembly to move, and then drives the elevating assembly to move relative to the bottom cover, which can improve the convenience of the existing projection device in adjusting the pitch angle. In addition, the movement of the elevating assembly is adjusted according to the driving amount of the driving assembly, which is a stepless adjustment and can more accurately control the height of the elevating assembly extending out of the projection device, thereby improving the problem of poor adjustment efficiency in the pitch angle of the existing projection device. Moreover, the linkage support assembly is connected to one end of the elevating assembly located in the projection device, so that the elevating assembly does not detach from the bottom of the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a stereoscopic diagram of a projection device according to an embodiment of the present invention;

FIG. 2 is a partial exploded diagram of FIG. 1;

FIG. 3 is a stereoscopic diagram of a first embodiment of an angle adjustment module of the present invention applied to a projection device;

FIG. 4 is an exploded diagram of FIG. 3;

FIG. 5 is a cross-sectional diagram along line AA’ in FIG. 3;

FIG. 6 is a schematic diagram of the elevating assembly of FIG. 5 moving toward the outside of the projection device;

FIG. 7 is a circuit block diagram of the angle adjustment module of FIG. 3;

FIG. 8 is an assembly diagram of the driving assembly and the transmission assembly of FIG. 4;

FIG. 9 is an assembly diagram of the linkage support assembly and the elevating assembly of FIG. 3;

FIG. 10 is a stereoscopic diagram of a second embodiment of an angle adjustment module of the present invention applied to a projection device;

FIG. 11 is an exploded diagram of FIG. 10;

FIG. 12 is a cross-sectional diagram along line BB’ in FIG. 10;

FIG. 13 is a schematic diagram of the elevating assembly of FIG. 12 moving toward the outside of the projection device;

FIG. 14 is a circuit block diagram of the angle adjustment module of FIG. 10;

FIG. 15 is a stereoscopic diagram of a third embodiment of an angle adjustment module of the present invention applied to a projection device;

FIG. 16 is an exploded view of FIG. 15;

FIG. 17 is a cross-sectional diagram along line CC’ in FIG. 15;

FIG. 18 is a schematic diagram of the elevating assembly of FIG. 17 moving toward the outside of the projection device;

FIG. 19 is a stereoscopic diagram of a fourth embodiment of an angle adjustment module of the present invention applied to a projection device;

FIG. 20 is an exploded view of FIG. 19;

FIG. 21 is an assembly diagram of the driving assembly and the transmission assembly of FIG. 19;

FIG. 22 is an assembly diagram of the linkage support assembly and the elevating assembly of FIG. 19;

FIG. 23 is a stereoscopic diagram of a fifth embodiment of an angle adjustment module of the present invention applied to a projection device;

FIG. 24 is an exploded view of FIG. 23;

FIG. 25 is a stereoscopic diagram of a sixth embodiment of an angle adjustment module of the present invention applied to a projection device;

FIG. 26 is an exploded view of FIG. 25;

FIG. 27 is an assembly diagram of the driving assembly and the transmission assembly of FIG. 26;

FIG. 28 is an assembly diagram of the linkage support assembly and the elevating assembly of FIG. 26;

FIG. 29 is a stereoscopic diagram of a seventh embodiment of an angle adjustment module of the present invention applied to a projection device;

FIG. 30 is an exploded view of FIG. 29;

FIG. 31 is a cross-sectional diagram along line DD’ in FIG. 29;

FIG. 32 is a schematic diagram of the elevating assembly of FIG. 31 moving toward the outside of the projection device;

FIG. 33 is a circuit block diagram of the angle adjustment module of FIG. 29;

FIG. 34 is a stereoscopic diagram of a eighth embodiment of an angle adjustment module of the present invention applied to a projection device;

FIG. 35 is an exploded view of FIG. 34;

FIG. 36 is a cross-sectional diagram along line EE’ in FIG. 34;

FIG. 37 is a schematic diagram of the elevating assembly of FIG. 36 moving toward the outside of the projection device;

FIG. 38 is a stereoscopic schematic diagram of FIG. 37;

FIG. 39 is a circuit block diagram of the angle adjustment module of FIG. 34;

FIG. 40 is a stereoscopic diagram of a ninth embodiment of an angle adjustment module of the present invention applied to a projection device;

FIG. 41 is an exploded view of FIG. 40;

FIG. 42 is a cross-sectional diagram along line FF’ in FIG. 40;

FIG. 43 is a circuit block diagram of the elevating assembly of FIG. 42;

FIG. 44 is a schematic diagram of the angle adjustment module of FIG. 43; and

FIG. 45 is a circuit diagram of the angle adjustment module of FIG. 40.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

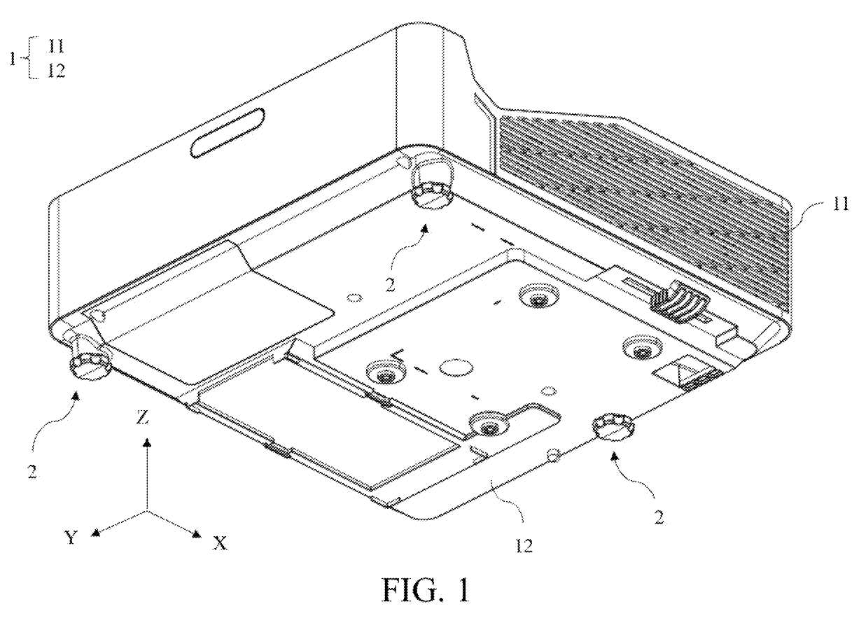

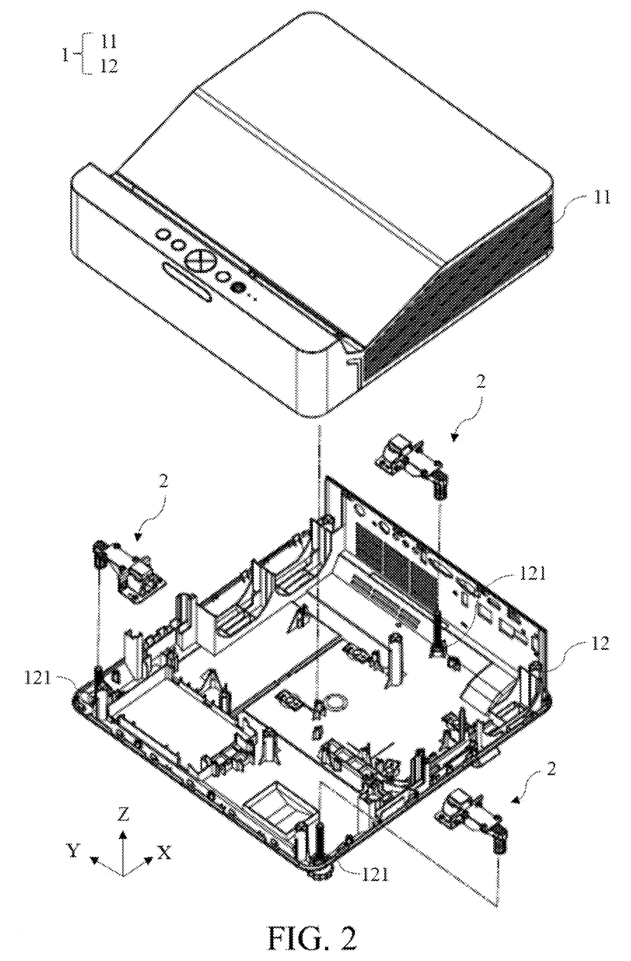

Please refer to FIGS. 1 and 2. FIG. 1 is a stereoscopic diagram of a projection device according to an embodiment of the present invention, and FIG. 2 is a partial exploded diagram of FIG. 1. As shown in FIGS. 1 and 2, a projection device 1 comprises a top cover 11, a bottom cover 12 and an angle adjustment module 2. The top cover 11 comprises, for example, an upper cover and a side cover, and the bottom cover 12 is, for example, a lower cover. The top cover 11 and the bottom cover 12 are assembled to form an accommodation space (not shown). At least a part of the light source, optical element, electronic element, heat dissipation element, optical machine and projection lens of the projection device 1 are, for example, arranged in the accommodation space. A direction along the short side of the bottom cover 12 is defined as an X-axis direction, a direction along the long side of the bottom cover 12 is defined as a Y-axis direction, a direction along the thickness of the projection device 1 is defined as a Z- axis direction, and the X-axis direction, the Y-axis direction and the Z-axis direction are orthogonal to each other.

In this embodiment, the bottom cover 12 is provided with at least one opening 121, the number of the angle adjustment module 2 is at least one, the opening 121 and the angle adjustment module 2 are arranged in one-to-one correspondence, and the number of opening 121 and the number of angle adjustment module 2 may be adjusted according to actual needs. For example, when there is only one angle adjustment module 2, the angle adjustment module 2 may adjust the pitch angle of projection device 1; when there are a plurality of angle adjustment modules 2, the plurality of angle adjustment modules 2 may not only adjust the pitch angle of projection device 1, but also allow projection device 1 to be stably set on a carrier (e.g., a table or a workbench) with an uneven surface and may correct the distorted projection images in different directions. The method of adjusting the pitch angle of the projection device 1 by angle adjustment module 2 will be described in detail later.

In one embodiment, when the number of openings 121 and the number of angle adjustment modules 2 are four, the four openings 121 are, for example, located at the four corners of the bottom cover 12, and the four angle adjustment modules 2 correspond to the four openings 121. In another embodiment, when the number of openings 121 and the number of angle adjustment modules 2 are three, two of the three openings 121 are located at two corners corresponding to one long side of the bottom cover 12, and one of the three openings 121 is located at the center of another long side of the bottom cover 12, for example. The three angle adjustment modules 2 correspond to the three openings 121 (as shown in FIGS. 1 and 2). Since the plurality of angle adjustment modules 2 in the above embodiments are very similar or even identical to each other, the structural design of one angle adjustment module 2 will be described in detail below, and the structural designs of the other angle adjustment modules 2 may be deduced accordingly.

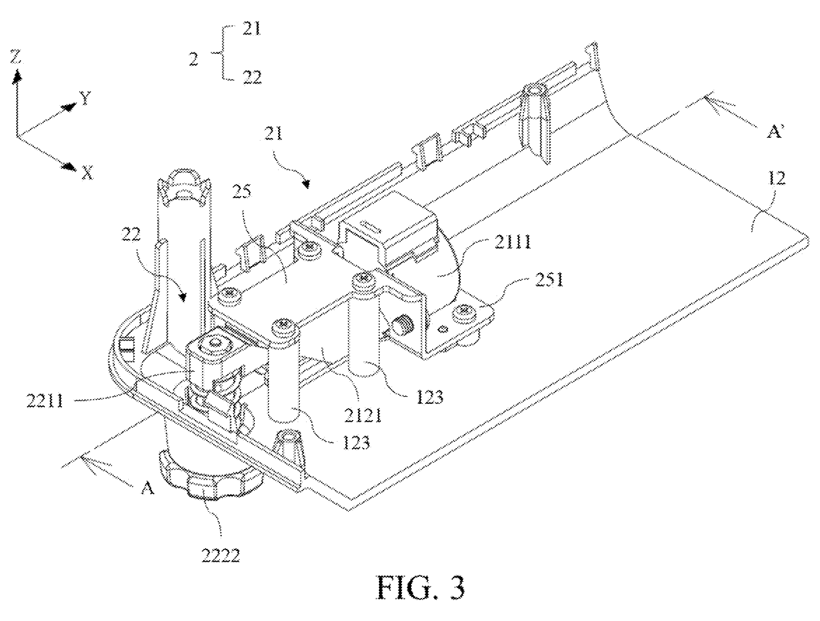

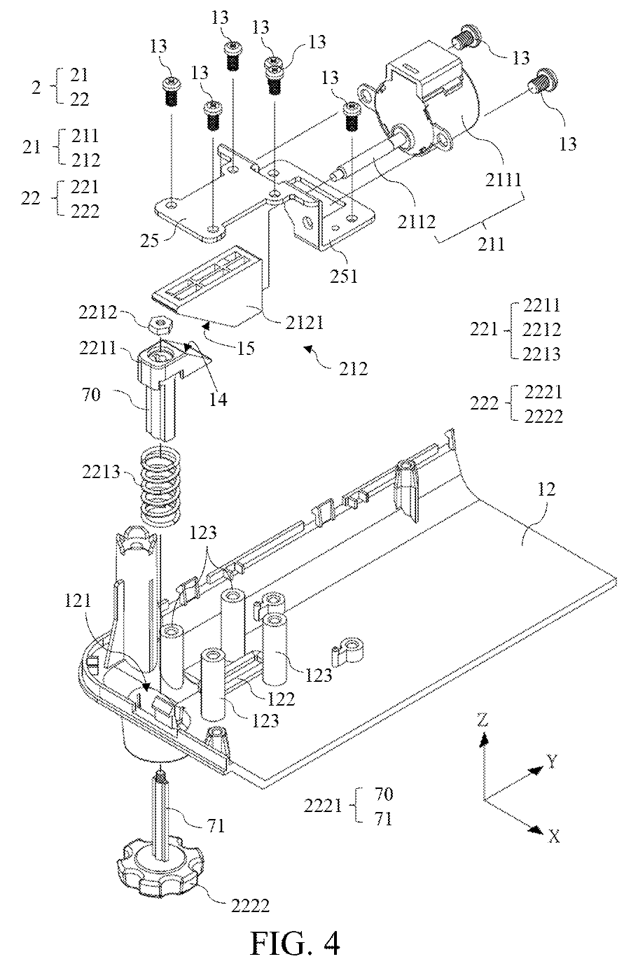

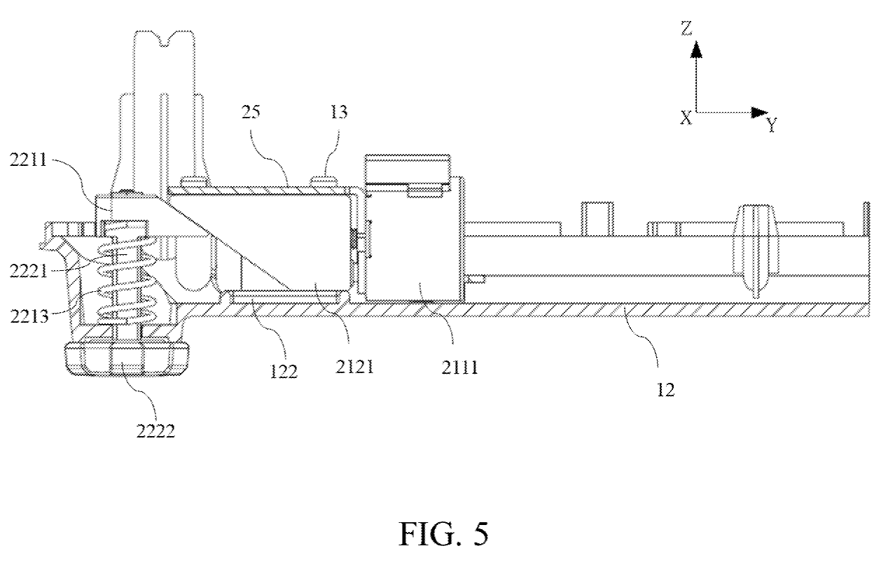

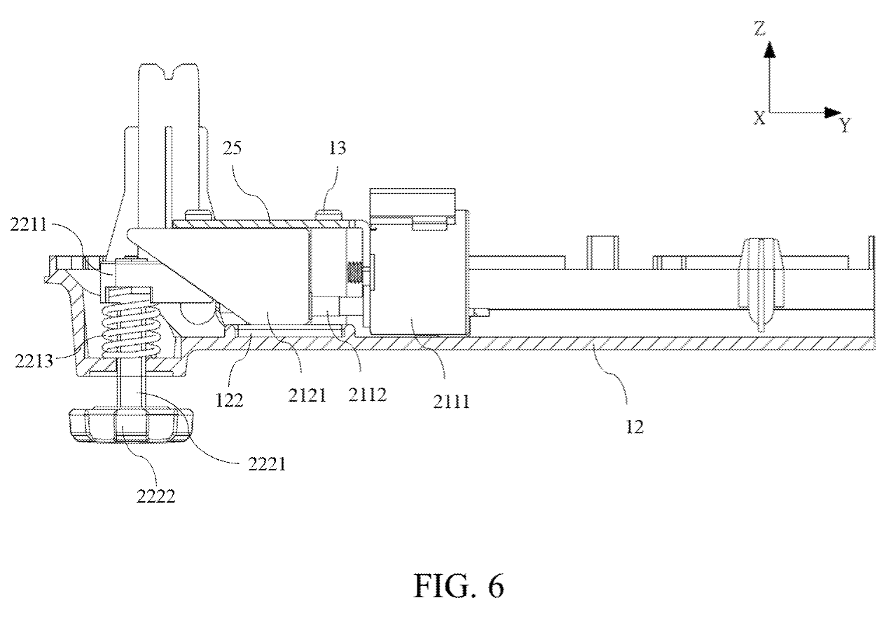

Please refer to FIGS. 3 to 6. FIG. 3 is a stereoscopic diagram of a first embodiment of an angle adjustment module of the present invention applied to a projection device, FIG. 4 is an exploded diagram of FIGS. 3, 5 is a cross-sectional diagram along line AA’ in FIGS. 3, and 6 is a schematic diagram of the elevating assembly of FIG. 5 moving toward the outside of the projection device. As shown in FIGS. 3 to 6, the angle adjustment module 2 comprises a driving device 21 and an elevating device 22, the driving device 21 is disposed in the projection device 1 (as shown in FIG. 2), the driving device 21 comprises a driving assembly 211 and a transmission assembly 212, and the elevating device 22 comprises a linkage support assembly 221 and an elevated assembly 222. The driving assembly 211 is disposed on the bottom cover 12, and one end of the transmission assembly 212 is connected to the driving assembly 211. The elevating assembly 222 passes through the opening 121 of the bottom cover 12 and moves relative to the bottom cover 12 in a direction (substantially) perpendicular to the bottom cover 12 (i.e., the Z-axis direction) to adjust a pitch angle of the projection device 1 (as shown in FIGS. 5 and 6). The linkage support assembly 221 is disposed in the projection device 1, and the linkage support assembly 221 is respectively connected to one end of the elevating assembly 222 located in the projection device 1 and the other end of the transmission assembly 212 to drive the elevating assembly 222 to move relative to the bottom cover 12, and provide a static support force for the elevating assembly 222. The static support force is a force that allows the elevating assembly 222 to maintain its current state when the driving assembly 211 does not drive the elevating assembly 222 to move.

Therefore, by driving the driving assembly 211 via the transmission assembly 212, the transmission assembly 212 drives the linkage support assembly 221 to move, thereby moving the elevating assembly 222 relative to the bottom cover 12, which can improve the convenience of adjusting the pitch angle of the existing projection device. In addition, adjusting the movement of the elevating assembly 222 by controlling the driving amount of the driving assembly 211 is a kind of stepless adjustment, which can more accurately control the length of the elevating assembly 222 extending from the projection device 1, thereby improving the problem of poor efficiency in adjusting the pitch angle of the existing projection device. Moreover, by connecting the linkage support assembly 221 to one end of the elevating assembly 222 located in the projection device 1, the elevating assembly 222 does not detach from the bottom of the projection device 1.

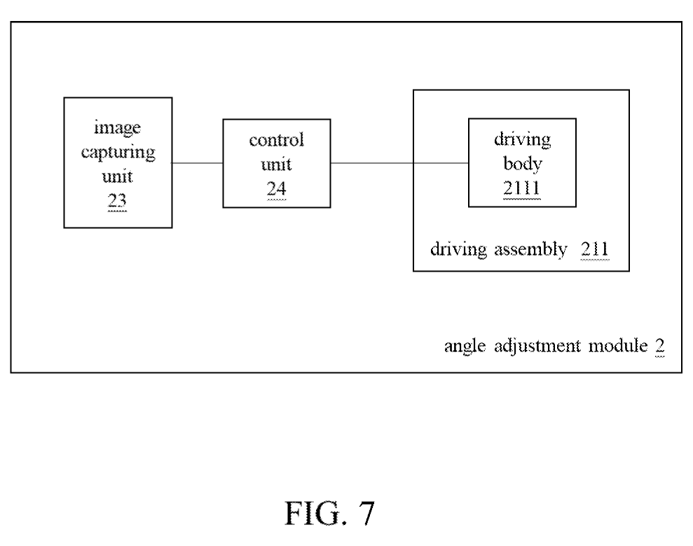

Please refer to FIG. 7, which is a circuit block diagram of the angle adjustment module of FIG. 3. As shown in FIG. 7, the angle adjustment module 2 may further comprise a control unit 24, which is connected to the driving assembly 211 and is arranged at any position in the projection device 1. In one embodiment, the angle adjustment module 2 may further comprise an image capturing unit 23, and the image capturing unit 23 is connected to the control unit 24. The image capturing unit 23 is configured to capture a captured image corresponding to the projection image of the projection device 1 and transmit the captured image to the control unit 24, so that the control unit 24 controls the driving assembly 211 based on the captured image, thereby adjusting the projection image. The control unit 24 may be, for example, a central processing unit (CPU), a microprocessor, a digital signal processor (DSP), a programmable controller, a programmable logic device (PLD) or other similar devices or a combination thereof, but is not limited thereto. Please refer to FIGS. 3 to 7, the control unit 24 may control the driving amount of the driving assembly 211 to adjust the movement of the elevating assembly 222 accordingly. The control unit 24 may further control the driving assembly 211 at any time based on the degree of distortion of the actual projection image in the captured image, thereby adjusting the movement of the elevating assembly 222 to meet the full-automatic real-time dynamic adjustment of the projection image of the projection device 1 (i.e., automatic adjustment of the skewness/keystone of the projection image).

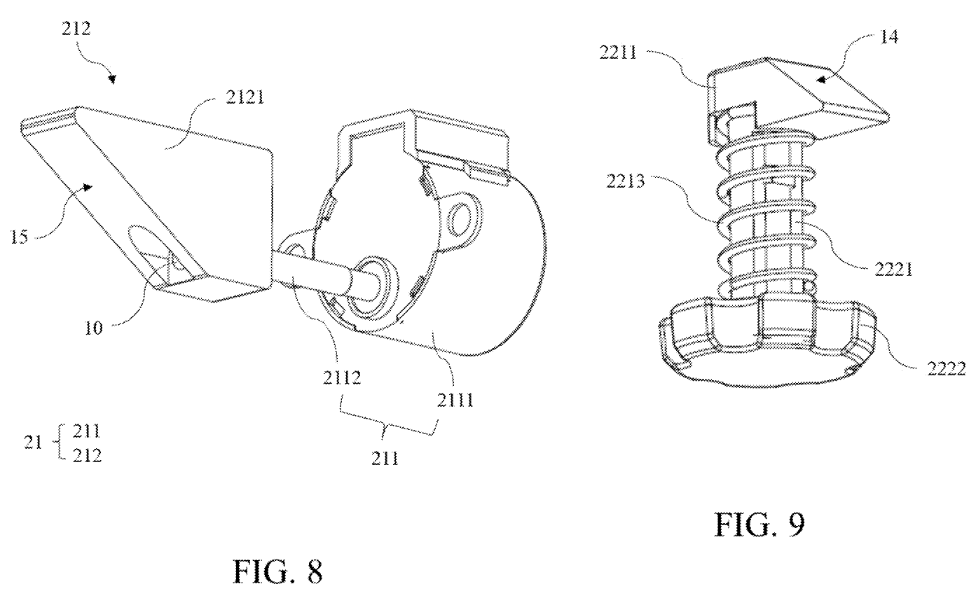

Please refer to FIGS. 4 and 8. FIG. 8 is an assembly diagram of the driving assembly and the transmission assembly of FIG. 4. As shown in FIGS. 4 and 8, the driving assembly 211 may comprise a driving body 2111 and a driving shaft 2112, wherein the driving body 2111 is configured to drive the driving shaft 2112 to rotate, and the driving shaft 2112 is connected to the transmission assembly 212. Specifically, the driving body 2111 may be, for example, a driving motor, and the driving shaft 2112 may be, for example, a lead screw having an external thread, and one end of the driving shaft 2112 is threadedly connected to the transmission assembly 212. The transmission assembly 212 may comprise a wedge-shaped nut 2121, wherein the wedge-shaped nut 2121 is provided with a hole 10, and the hole 10 is configured to rotatably engage with the driving shaft 2112. Specifically, the hole 10 is provided with an internal thread, so that the hole 10 may be rotatably engaged with one end of a lead screw as the driving shaft 2112. The friction angle between the external thread of the lead screw and the internal thread of the hole 10 may result in a self-locking phenomenon, so that when the control unit 24 stops supplying power to the driving body 2111 or the driving body 2111 stops operating, the wedge-shaped nut 2121 is not pushed back from the position of FIG. 6 to the position of FIG. 5.

Please refer to FIGS. 3 to 6, the bottom cover 12 may further be provided with a supporting protrusion 122 for supporting the wedge-shaped nut 2121 and a plurality of fixing columns 123 around the supporting protrusion 122, and the angle adjustment module 2 may further comprise a fixing plate 25, and the fixing plate 25 is fixed on the plurality of fixing columns 123. Since the fixing plate 25 and the supporting protrusion 122 of the bottom cover 12 are located above and below the wedge-shaped nut 2121 respectively, and the plurality of fixing columns 123 are located around the wedge-shaped nut 2121 (e.g., on the left and right of the wedge-shaped nut 2121). Therefore, the fixing plate 25, the supporting protrusion 122 and the plurality of fixing columns 123 enable the wedge-shaped nut 2121 to perform a translational movement in a direction parallel to the bottom cover 12 (i.e., in the Y-axis direction). That is, the arrangement of the fixing plate 25, the supporting protrusion 122 and the plurality of fixing columns 123 may limit the rotational movement of the wedge-shaped nut 2121 when the driving shaft 2112 drives the wedge-shaped nut 2121 to operate, so that the wedge-shaped nut 2121 may only move linearly back and forth along the Y-axis direction. For example, when the driving body 2111 drives the driving shaft 2112 to rotate clockwise, the driving shaft 2112 drives the wedge-shaped nut 2121 to move along a negative Y-axis direction. That is, the angle adjustment module 2 operates from FIGS. 5 to 6. When the driving body 2111 drives the driving shaft 2112 to rotate counterclockwise, the driving shaft 2112 drives the wedge-shaped nut 2121 to move along a positive Y-axis direction. That is, the angle adjustment module 2 operates from FIGS. 6 to 5. The number of fixing columns 123 may be, but is not limited to, four, and the actual number may be adjusted according to actual needs. In addition to limiting the rotation of the wedge-shaped nut 2121, the fixing plate 25 may also extend a fixing bracket 251 that supports the driving body 2111. The fixing plate 25 may be fixed to the plurality of fixing columns 123 by means of the screws 13, and the driving body 2111 may be locked to the fixing bracket 251 and the bottom cover 12 by means of the screws 13.

Please refer to FIGS. 4 to 9. FIG. 9 is an assembly diagram of the linkage support assembly and the elevating assembly of FIG. 3. As shown in FIGS. 4 to 9, the linkage support assembly 221 may comprise a wedge block 2211, and the elevating assembly 222 may comprise a supporting rod 2221 locked to the wedge block 2211. A first inclined surface 14 of the wedge block 2211 is parallel to a second inclined surface 15 of the wedge-shaped nut 2121. When the driving body 2111 drives the wedge-shaped nut 2121 to perform the translational movement in the direction parallel to the bottom cover 12 (i.e., the Y-axis direction) through the driving shaft 2112, the wedge-shaped nut 2121 pushes the wedge block 2211 through the second inclined surface 15, so that the supporting rod 2221 moves in the direction perpendicular to the bottom cover 12 (i.e., the Z-axis direction). The linkage support assembly 221 may further comprise a fastening nut 2212, and the supporting rod 2221 may comprise an outer rod 70 and an inner rod 71. The outer rod 70 is fixedly disposed at the bottom of the wedge block 2211, the inner rod 71 is sleeved inside the outer rod 70, and the inner rod 71 passes through the wedge block 2211 and is screwed into the fastening nut 2212 (that is, one end of the supporting rod 2221 of the elevating assembly 222 passes through the wedge block 2211 and is screwed into the fastening nut 2212), so that the supporting rod 2221 is locked to the wedge block 2211, but the invention is not limited thereto. In addition, a foot pad 2222 is disposed at the other end of the supporting rod 2221. That is, the foot pad 2222 is disposed at one end of the inner rod 71 away from the fastening nut 2212.

In this embodiment, when the driving body 2111 drives the wedge-shaped nut 2121 to move along the negative Y-axis direction through the driving shaft 2112, the wedge-shaped nut 2121 transmits the component of thrust to the wedge block 2211 in a sliding manner, so that the wedge block 2211 drives the supporting rod 2221 to move along a negative Z-axis direction. That is, the angle adjustment module 2 operates from FIGS. 5 to 6. In addition, the first inclined surface 14 of the wedge block 2211 and the second inclined surface 15 of the wedge-shaped nut 2121 may be planes with a certain degree of roughness, and the effective friction between the first inclined surface 14 and the second inclined surface 15 may result in a self-locking phenomenon to enhance the function of preventing loosening. That is, as long as the friction coefficient is sufficient, the first inclined surface 14 and the second inclined surface 15 are self-locking structures. The wedge block 2211 and the wedge-shaped nut 2121 may be made of wear-resistant materials, such as plastic steel, nylon and metal.

In order to make the driving body 2111 drive the wedge-shaped nut 2121 to move along the positive Y-axis direction through the driving shaft 2112 (that is, the angle adjustment module 2 operates from FIGS. 6 to 5), the second inclined surface 15 of the wedge-shaped nut 2121 may still maintain close contact with the first inclined surface 14 of the wedge block 2211, and the elevating assembly 222 may move along a positive Z-axis direction, which may be achieved by the arrangement of an elastic element 2213. Please refer to FIGS. 3 to 6. The linkage support assembly 221 may further comprise an elastic element 2213, which is sleeved on the supporting rod 2221 and two sides of the elastic element 2213 abut the wedge block 2211 and the bottom cover 12 respectively. When the wedge-shaped nut 2121 performs the translational movement in the direction parallel to the bottom cover 12 (i.e., the Y-axis direction), the wedge-shaped nut 2121 compresses the elastic element 2213 by pushing the wedge block 2211, or the wedge block 2211 is pushed by a restoring force of the elastic element 2213. The elastic element 2213 is configured to provide the static support force for the elevating assembly 222. The elastic element 2213 may be, but is not limited to, a compression spring.

Specifically, when the driving body 2111 drives the wedge-shaped nut 2121 to move along the negative Y-axis direction through the driving shaft 2112 (that is, the angle adjustment module 2 operates from FIGS. 5 to 6), the wedge-shaped nut 2121 transmits the component of thrust to the wedge block 2211 in a sliding manner. Since the pushing force of the wedge-shaped nut 2121 is greater than the sum of the elastic force of the elastic element 2213 and the gravity of the projection device 1 carried by the elevating assembly 222, the wedge block 2211 drives the supporting rod 2221 to move along the negative Z-axis direction and compress the elastic element 2213. When the driving body 2111 drives the wedge-shaped nut 2121 to move along the positive Y-axis direction through the driving shaft 2112 (that is, the angle adjustment module 2 operates from FIGS. 6 to 5), the restoring force of the elastic element 2213 pushes the wedge block 2211, so that the elevating assembly 222 may move along the positive Z-axis direction, and the second inclined surface 15 of the wedge-shaped nut 2121 may still maintain close contact with the first inclined surface 14 of the wedge block 2211. Therefore, the arrangement of the elastic element 2213 may enable the supporting rod 2221 to move in the direction perpendicular to the bottom cover 12 (i.e., the Z-axis direction), and at the same time provide the static support force for the elevating assembly 222. In addition, the arrangement of the elastic element 2213 may further ensure that the supporting rod 2221 does not rotate or shake arbitrarily. Moreover, according to the above, it can be seen that the supporting rod 2221 is used to bear part of the gravity of the projection device 1, so the appearance of the supporting rod 2221 is not restricted, so that the design of the supporting rod 2221 may be more variable and flexible. Furthermore, the angle adjustment module 2 moves relative to the bottom cover 12 when the elevating assembly 222 is driven by the driving device 21. There is no need to manually adjust the elevating assembly 222. Therefore, the appearance of the foot pad 2222 is not restricted, making the design of the foot pad 2222 more varied and flexible.

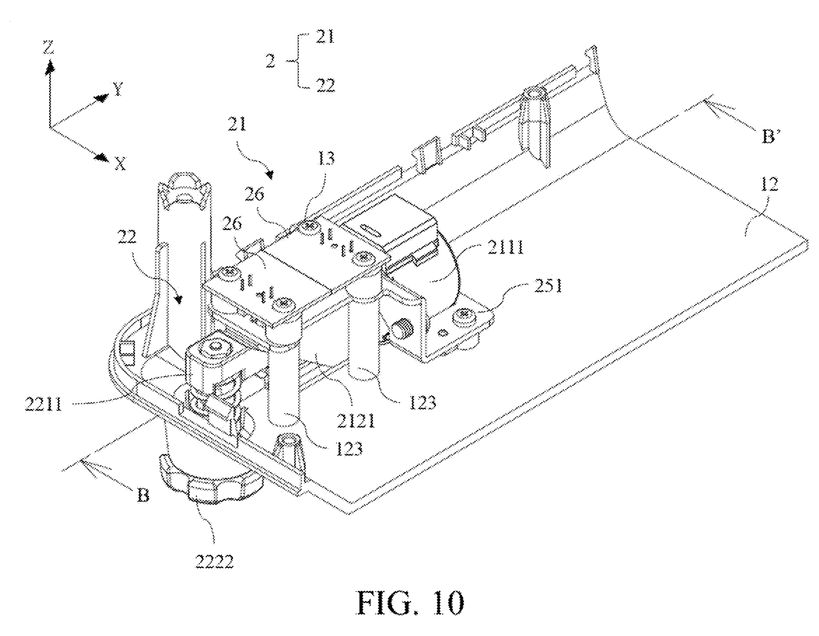

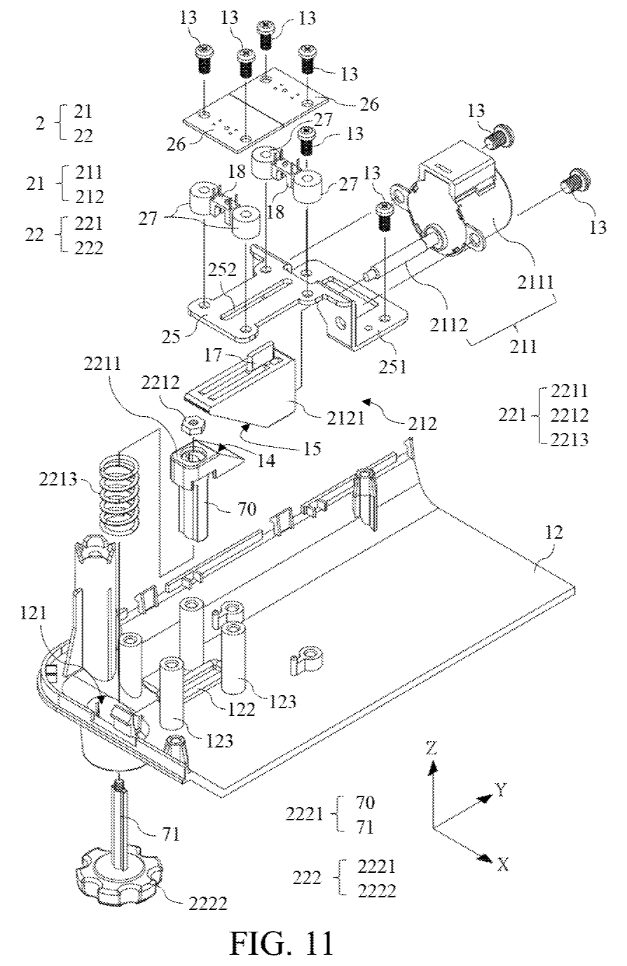

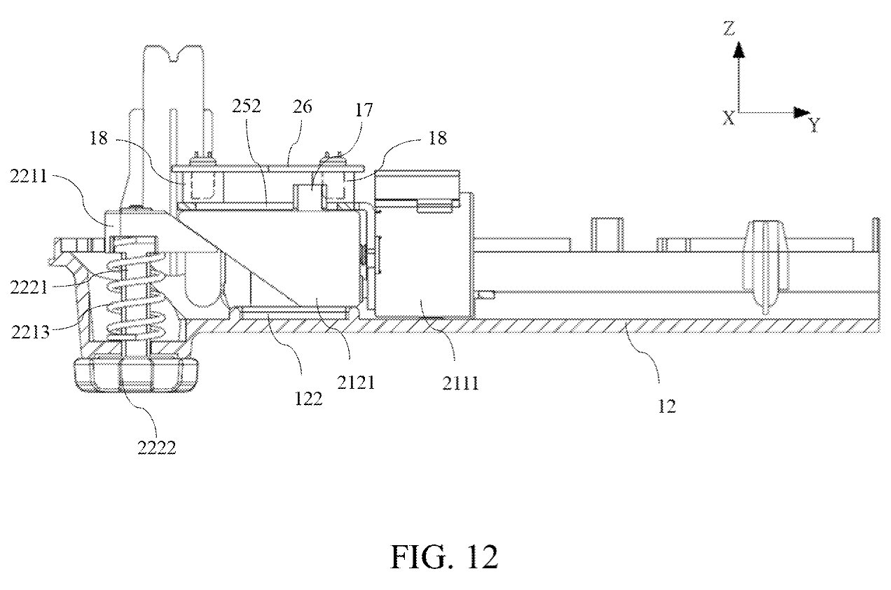

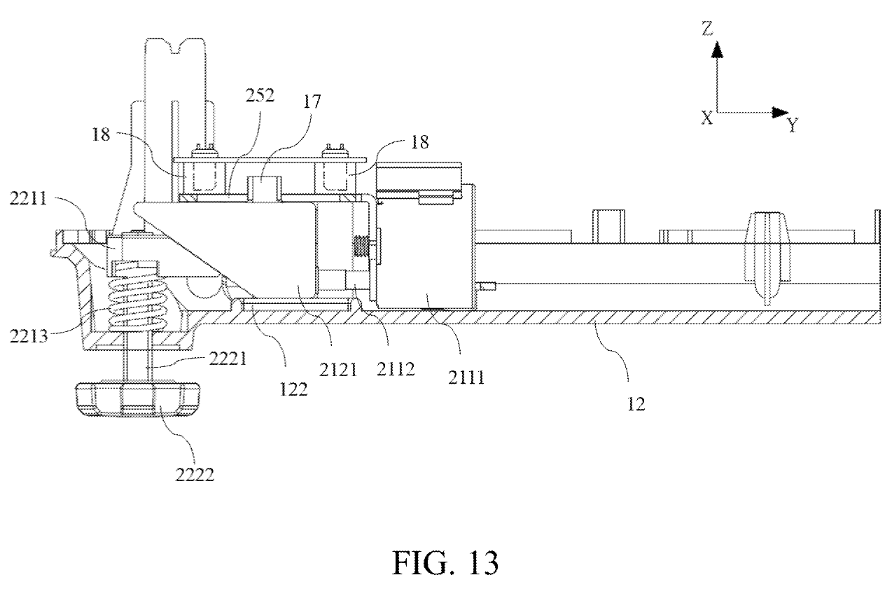

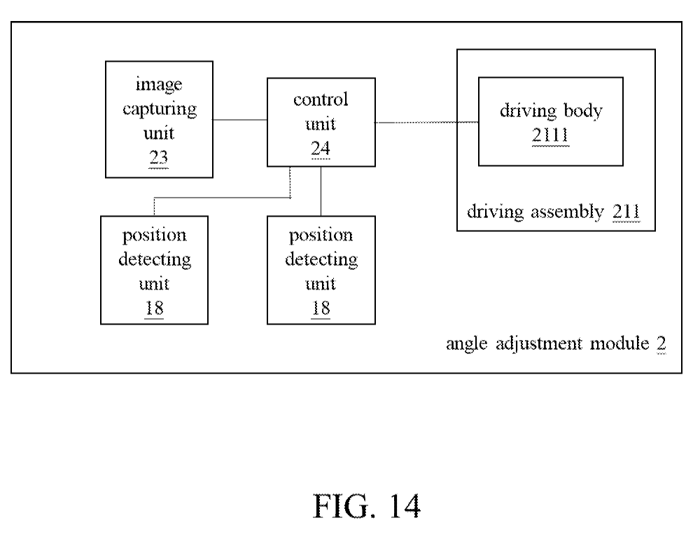

Please refer to FIGS. 10 to 13. FIG. 10 is a stereoscopic diagram of a second embodiment of an angle adjustment module of the present invention applied to a projection device, FIG. 11 is an exploded diagram of FIGS. 10, 12 is a cross-sectional diagram along line BB’ in FIGS. 10, and 13 is a schematic diagram of the elevating assembly of FIG. 12 moving toward the outside of the projection device. The difference between the embodiment of FIGS. 10 to 13 and the embodiment of FIGS. 3 to 6 is that the angle adjustment module 2 of FIGS. 10 to 13 is further provided with a mechanism for detecting a current position of the wedge-shaped nut 2121. Specifically, in FIGS. 10 to 13, the fixing plate 25 may have a linear slot 252 which is parallel to the Y-axis direction, a top portion of the wedge-shaped nut 2121 has a baffle 17, the baffle 17 is adapted to pass through the linear slot 252. When the wedge-shaped nut 2121 performs the translational movement in the direction parallel to the bottom cover 12 (i.e., the Y-axis direction), the baffle 17 moves along the linear slot 252. The angle adjustment module 2 may further comprise a plurality of position detecting units 18 on the fixing plate 25, and the control unit 24 is electrically connected to the plurality of position detecting units 18. The plurality of position detecting units 18 are located on at least one side of a movement trajectory of the baffle 17 and are configured to detect a current position of the baffle 17, and transmit a detection result to the control unit 24, so that the control unit 24 controls the driving assembly 211/driving body 2111 based on the detection result. In order to avoid over-complication of the drawings of FIGS. 9 to 12, the control unit 24 and its electrical connection relationship with the position detecting units 18 and the driving assembly 211/driving body 2111 are only drawn in FIG. 14, which is a circuit block diagram of the angle adjustment module of FIG. 10. The circuit of the angle adjustment module 2 of FIG. 14 may also selectively comprise the image capturing unit 23 of FIG. 7, so as to control the driving assembly 211 at any time based on the degree of distortion of the actual projection image in the captured image, thereby adjusting the operation of the elevating assembly 222. In one embodiment, the angle adjustment module 2 may further comprise a plurality of circuit boards 26 and a plurality of spacer columns 27, wherein the plurality of spacer columns 27 are disposed between the plurality of circuit boards 26 and the fixing plate 25. The plurality of position detecting units 18 are disposed on the plurality of circuit boards 26 and face the fixing plate 25, and the plurality of position detecting units 18 are located on at least one side of the movement trajectory of the baffle 17. The plurality of circuit boards 26, the plurality of spacer columns 27, the fixing plate 25 and the plurality of fixing columns 123 are locked together by a plurality of screws 13. The circuit boards 26 and the position detecting units 18 may be arranged in one-to-one correspondence. The number of circuit boards 26 and the number of position detecting units 18 may be the same, and the actual number of circuit boards 26, the actual number of position detecting units 18, and the corresponding relationship between the circuit boards 26 and the position detecting units 18 may be adjusted according to actual needs. The number of spacer columns 27 may be, but is not limited to, four, and the four spacer columns 27 may be located at the four corners of the fixing plate 25 respectively.

In this embodiment, the control unit 24 may obtain the current position of the baffle 17 (i.e., the current position of the wedge-shaped nut 2121) through the detection result, and control the driving assembly 211/driving body 2111 to stop operating when it is determined that the baffle 17 is located at the limit of the detection range formed by the plurality of position detecting units 18, so as to prevent the wedge-shaped nut 2121 from exceeding the pre-designed working range and colliding with other components, thereby causing damage. The position detecting unit 18 may be, but is not limited to, an infrared detection unit, a laser ranging unit or an image capture unit, and the number of position detecting units 18 may be adjusted according to actual needs. The larger the number of position detecting units 18, the more accurate the current position of the baffle 17 (i.e., the current position of the wedge-shaped nut 2121) obtained by the control unit 24 through the plurality of position detecting units 18.

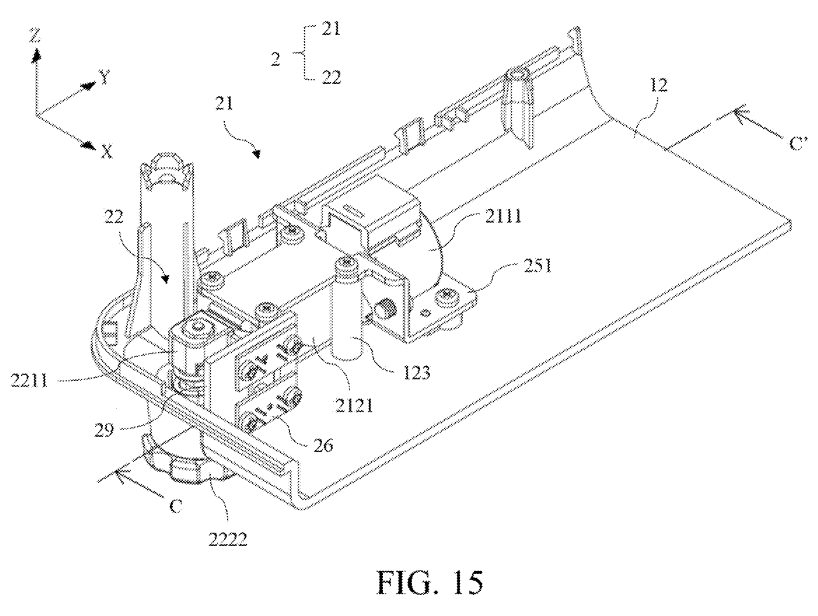

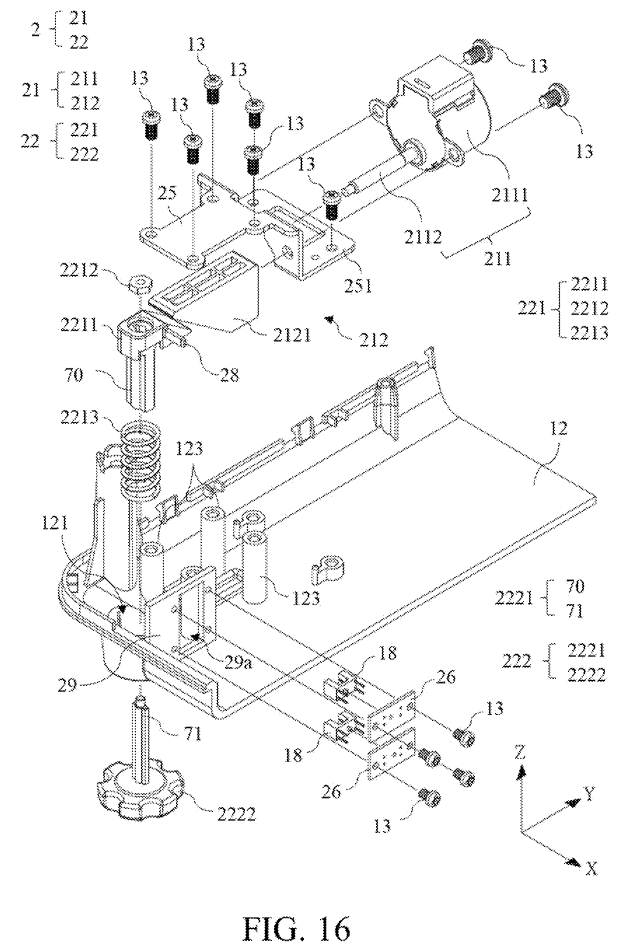

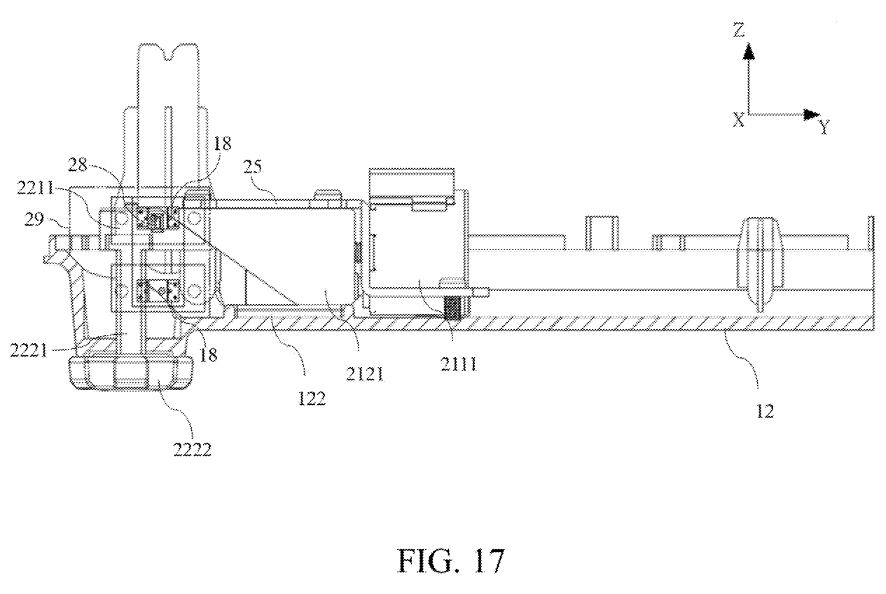

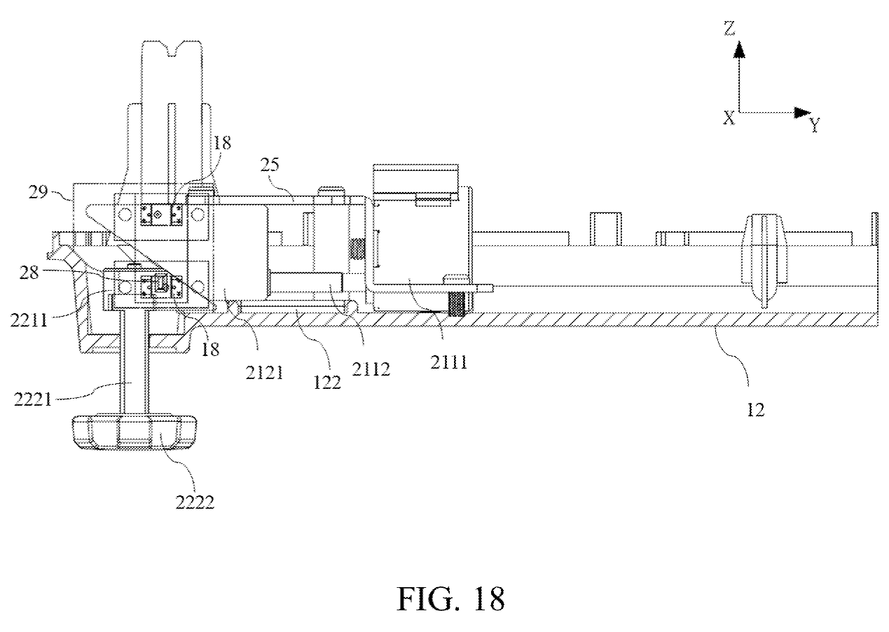

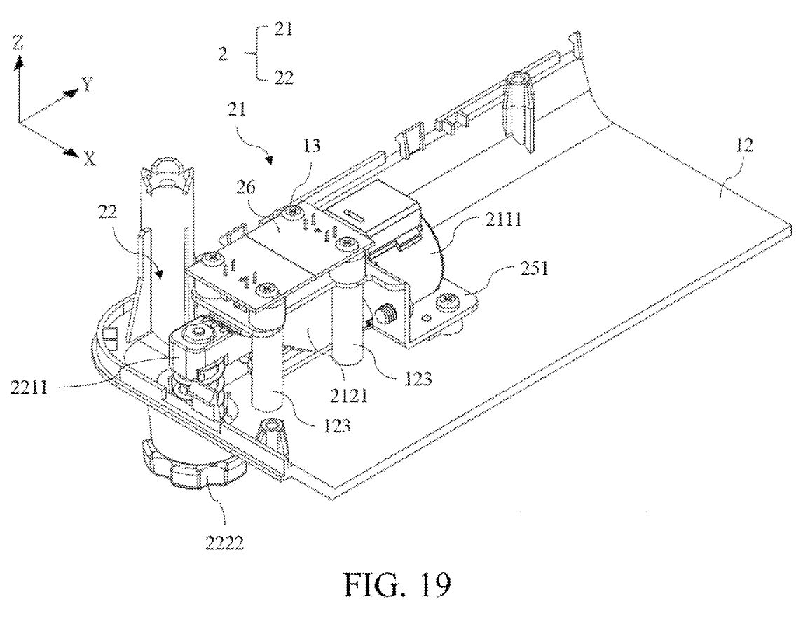

Please refer to FIGS. 15 to 18. FIG. 15 is a stereoscopic diagram of a third embodiment of an angle adjustment module of the present invention applied to a projection device, FIG. 16 is an exploded view of FIG. 15, FIG. 17 is a cross-sectional diagram along line CC’ in FIGS. 15, and 18 is a schematic diagram of the elevating assembly of FIG. 17 moving toward the outside of the projection device. The difference between the embodiment of FIGS. 15 to 18 and the embodiment of FIGS. 3 to 6 is that the angle adjustment module 2 of FIGS. 15 to 18 is further provided with a mechanism for detecting a current position of the wedge block 2211. Specifically, in FIGS. 15 to 18, one side of the wedge block 2211 of the linkage support assembly 221 has a baffle 28, the angle adjustment module 2 may further comprise a plurality of position detecting units 18 on a vertical plate 29 of the bottom cover 12, and the control unit 24 is electrically connected to the plurality of position detecting units 18. The plurality of position detecting units 18 are located on at least one side of the movement trajectory of the baffle 28 and are configured to detect a current position of the baffle 28, and transmit a detection result to the control unit 24, so that the control unit 24 controls the driving assembly 211/driving body 2111 based on the detection result. In order to avoid over-complication of the drawings of FIGS. 15 to 18, the control unit 24 and its electrical connection relationship with the position detecting units 18 and the driving assembly 211/driving body 2111 are not drawn. The control unit 24 of this embodiment and its electrical connection relationship with the position detecting units 18 and the driving assembly 211/driving body 2111 may be equivalent to FIG. 14, so the drawing of the circuit structure of FIGS. 15 to 18 is not drawn. That is, the circuit structure of the angle adjustment module 2 of FIGS. 15 to 18 may refer to FIG. 14. The vertical plate 29 may be provided with an opening 29a and be integrally formed with the bottom cover 12, but is not limited thereto. The angle adjustment module 2 may further comprise a plurality of circuit boards 26 and a plurality of screws 13. The plurality of circuit boards 26 and the vertical plate 29 are locked together by the plurality of screws 13. The plurality of position detecting units 18 are disposed on the plurality of circuit boards 26 and pass through the opening 29a, and the opening 29a exposes the plurality of position detecting units 18, so that the plurality of position detecting units 18 are located on at least one side of the movement trajectory of the baffle 28. It should be noted that in order to prevent the elastic element 2213 from covering the baffle 28 and the position detecting unit 18, the elastic element 2213 in FIGS. 17 and 18 is omitted.

In this embodiment, the control unit 24 may obtain the current position of the baffle 28 (i.e., the current position of the wedge block 2211) through the detection result, and control the driving assembly 211/driving body 2111 to stop operating when it is determined that the baffle 28 is located at the limit of the detection range formed by the plurality of position detecting units 18, so as to prevent the wedge block 2211/wedge-shaped nut 2121 from exceeding the pre-designed working range and colliding with other components, thereby causing damage. The number of position detecting units 18 and the number of circuit boards 26 may be, but are not limited to, two, the position detecting units 18 and the circuit boards 26 are arranged in one-to-one correspondence, and the number of position detecting units 18, the number of circuit boards 26, and the corresponding relationship between the position detecting units 18 and the circuit boards 26 may be adjusted according to actual needs. The larger the number of position detecting units 18, the more accurate the current position of the baffle 28 (i.e., the current position of the wedge block 2211) obtained by the control unit 24 through the plurality of position detecting units 18.

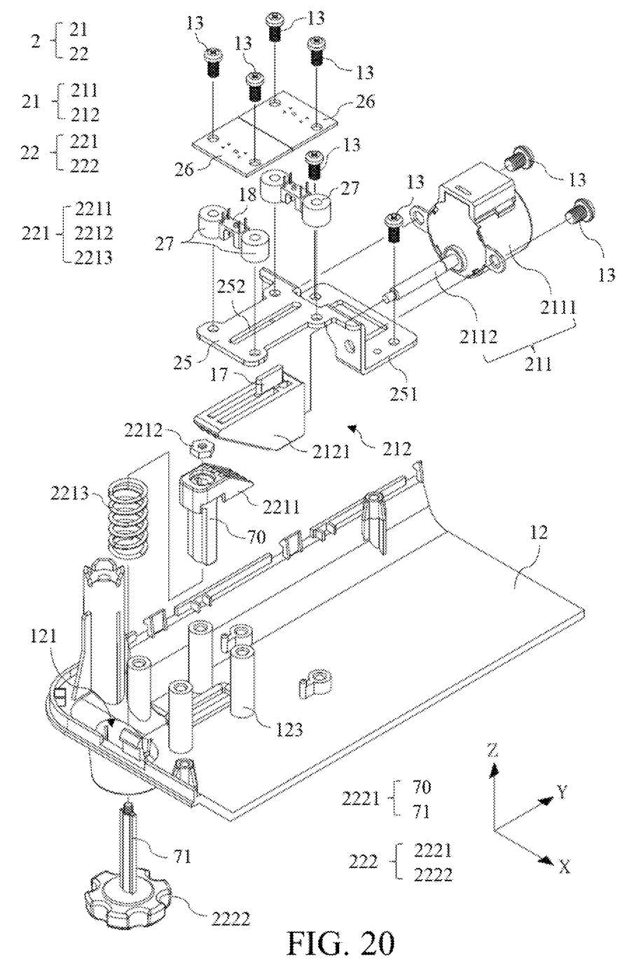

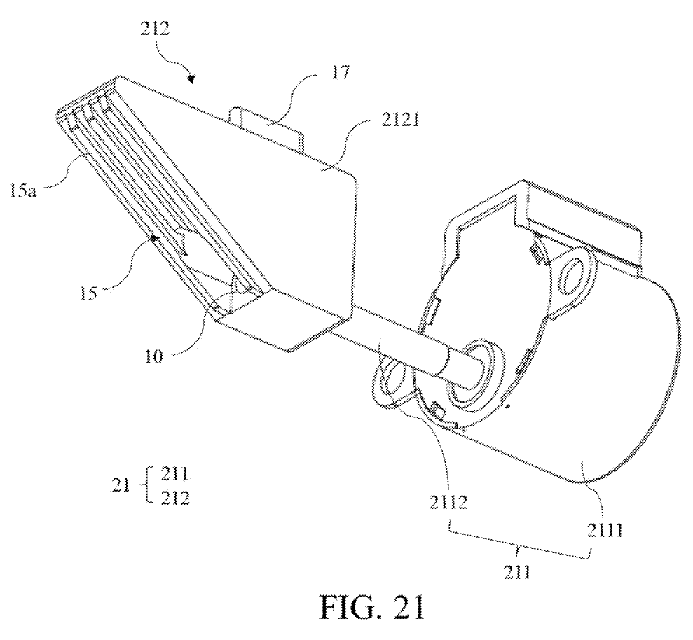

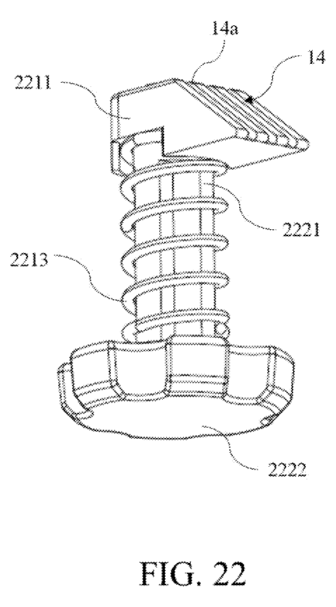

Please refer to FIGS. 19 to 22. FIG. 19 is a stereoscopic diagram of a fourth embodiment of an angle adjustment module of the present invention applied to a projection device, FIG. 20 is an exploded view of FIGS. 19, 21 is an assembly diagram of the driving assembly and the transmission assembly of FIGS. 19, and 22 is an assembly diagram of the linkage support assembly and the elevating assembly of FIG. 19. The difference between the embodiment of FIGS. 19 to 22 and the embodiment of FIGS. 10 to 13 is that the first inclined surface 14 of the wedge block 2211 and the second inclined surface 15 of the wedge-shaped nut 2121 in FIGS. 19 to 22 are not planes. Specifically, the first inclined surface 14 of the wedge block 2211 is provided with a groove 14a, the second inclined surface 15 of the wedge-shaped nut 2121 is provided with a rib 15a, and configuration positions of the groove 14a and the rib 15a correspond to each other. When the wedge-shaped nut 2121 pushes the wedge block 2211 through the second inclined surface 15, the rib 15a slides in the groove 14a, so that the wedge-shaped nut 2121 pushes the wedge block 2211. The number of the ribs 15a and the number of the grooves 14a are the same. For example, the number of the ribs 15a and the number of the grooves 14a may be three, the ribs 15a and the grooves 14a are arranged in one-to-one correspondence, and the number of ribs 15a and the number of grooves 14a may be adjusted according to actual needs. By the arrangements of rib 15a and groove 14a, the friction area and friction force between the first inclined surface 14 of the wedge block 2211 and the second inclined surface 15 of the wedge-shaped nut 2121 may be improved, resulting in a self-locking phenomenon.

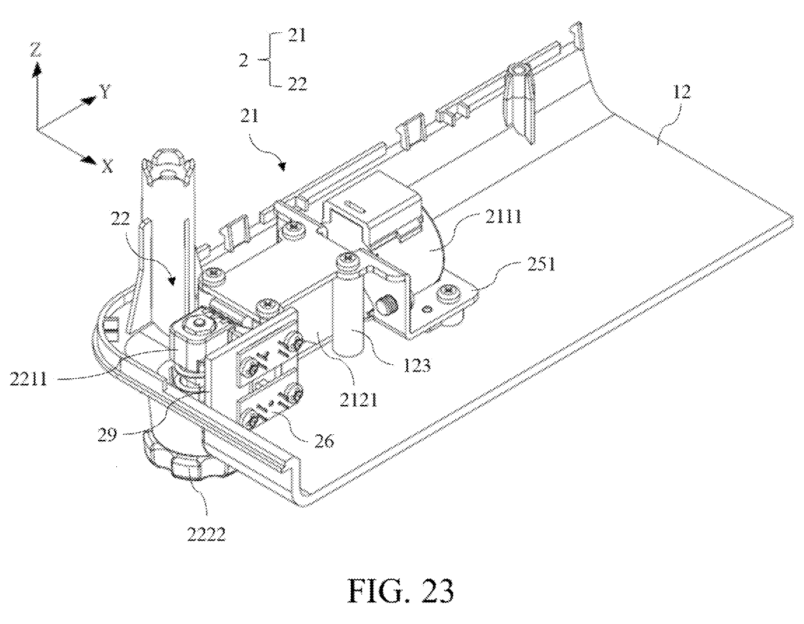

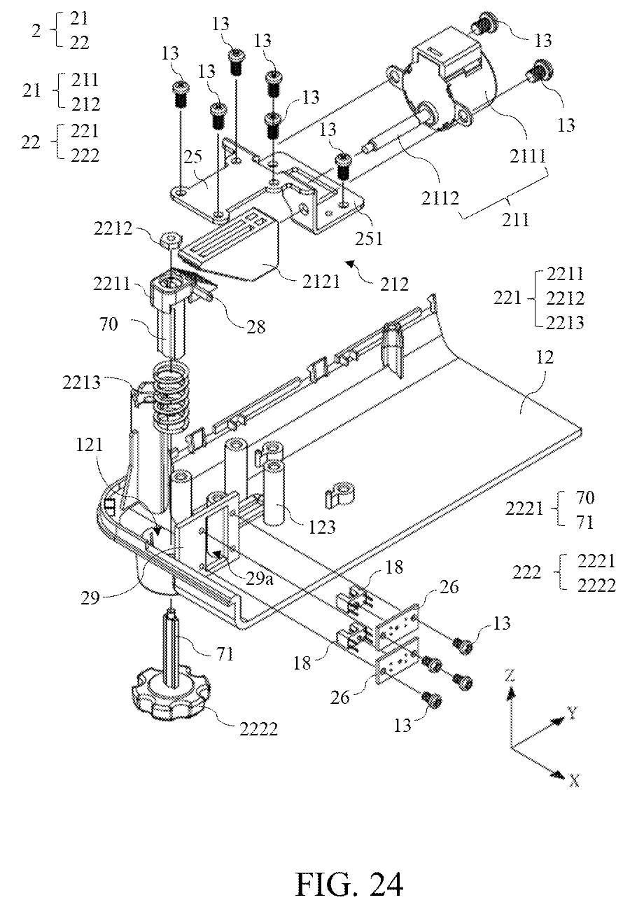

Please refer to FIGS. 23 and 24. FIG. 23 is a stereoscopic diagram of a fifth embodiment of an angle adjustment module of the present invention applied to a projection device, and FIG. 24 is an exploded view of FIG. 23. The difference between the embodiment of FIGS. 23 and 24 and the embodiment of FIGS. 15 to 18 is that the first inclined surface 14 of the wedge block 2211 and the second inclined surface 15 of the wedge-shaped nut 2121 in FIGS. 23 and 24 are not planes. Since the designs of the first inclined surface 14 of the wedge block 2211 and the second inclined surface 15 of the wedge-shaped nut 2121 in FIGS. 23 and 24 are the same as the designs of the first inclined surface 14 of the wedge block 2211 and the second inclined surface 15 of the wedge-shaped nut 2121 in FIG. 19 to FIG. 22, they will not be repeated here.

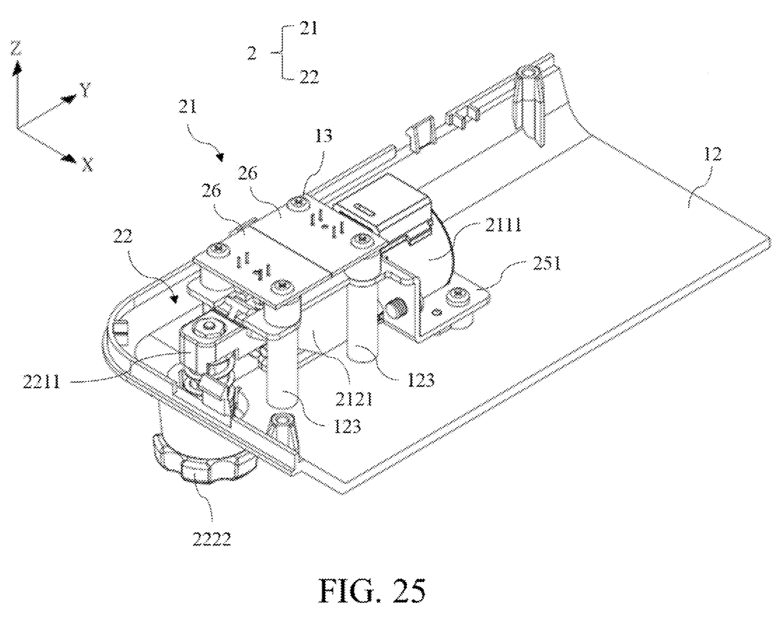

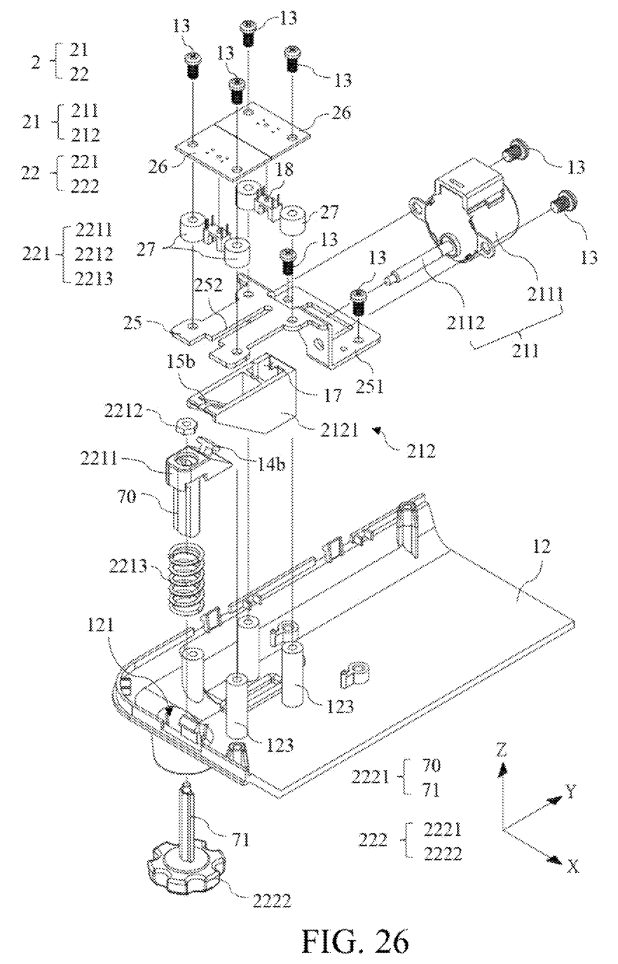

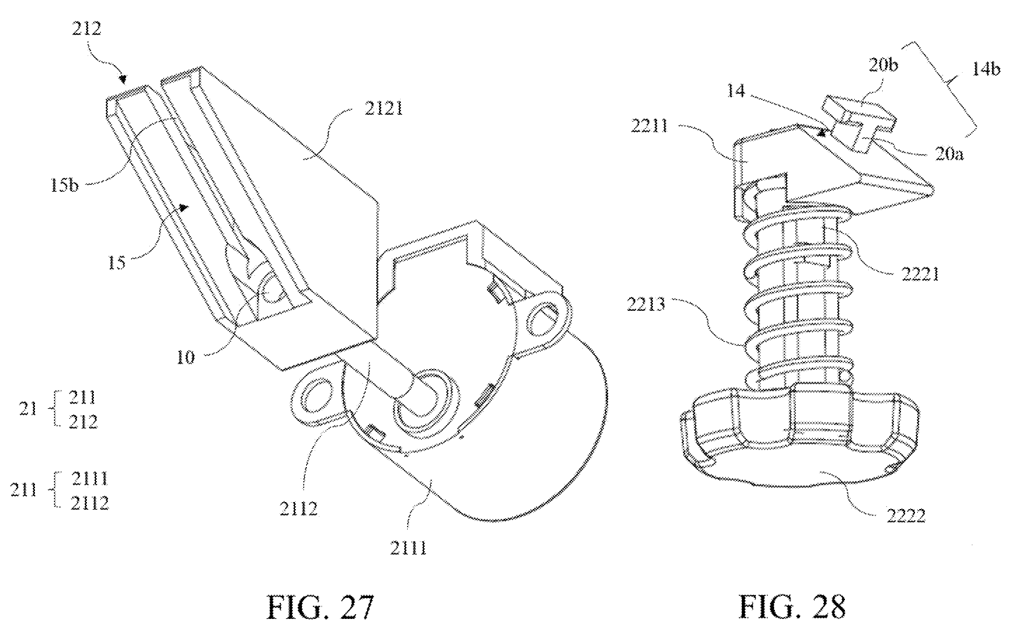

Please refer to FIGS. 25 to 28. FIG. 25 is a stereoscopic diagram of a sixth embodiment of an angle adjustment module of the present invention applied to a projection device, FIG. 26 is an exploded view of FIGS. 25, 27 is an assembly diagram of the driving assembly and the transmission assembly of FIGS. 26, and 28 is an assembly diagram of the linkage support assembly and the elevating assembly of FIG. 26. The difference between the embodiment of FIGS. 25 to 28 and the embodiment of FIGS. 10 to 13 is that the first inclined surface 14 of the wedge block 2211 and the second inclined surface 15 of the wedge-shaped nut 2121 in FIGS. 25 to 28 are not planes. Specifically, the second inclined surface 15 of the wedge-shaped nut 2121 is provided with a guide groove 15b, the first inclined surface 14 of the wedge block 2211 is provided with a tooth 14b, and the tooth 14b comprises a main tooth 20a standing on the first inclined surface 14 and a secondary tooth 20b extending from a top end of the main tooth 20a. When the wedge-shaped nut 2121 performs the translational movement in the direction parallel to the bottom cover 12 (i.e., the Y-axis direction), the main tooth 20a slides relatively along the guide groove 15b, and an orthographic projection of the secondary tooth 20b on the second inclined surface 15 at least partially overlaps an area outside the guide groove 15b on the second inclined surface 15. The linkage support assembly 221 provides the static support force for the elevating assembly 222 through the secondary tooth 20b. By the arrangement of the secondary tooth 20b (i.e., the projection area of the secondary tooth 20b on the second inclined surface 15 covers at least part of the area outside the guide groove 15b on the second inclined surface 15), when the driving assembly 211 does not drive the elevating assembly 222 to move, the wedge block 2211 will not fall down due to gravity, so that the elevating assembly 222 maintains the current state. The main tooth 20a and the secondary tooth 20b may form a T-shaped tooth, for example.

In addition, since the tooth 14b is designed as a T-shaped tooth, the wedge-shaped nut 2121 may directly drive the wedge block 2211 regardless of whether it moves along the positive Y-axis direction or the negative Y-axis direction, and the elastic element 2213 is only configured to maintain the stability of the elevating assembly 222, and does not need to bear the force of the elevating assembly 222 moving along the positive Z-axis direction.

In the angle adjustment module 2 of the first to sixth embodiments, it can be known that the driving body 2111 drives the wedge-shaped nut 2121 to perform the translational movement along the Y-axis direction through the driving shaft 2112, thereby driving the supporting rod 2221 to move along the Z-axis direction. Therefore, the driving device 21 of the angle adjustment module 2 may be designed to be placed horizontally, eliminating the height required for driving the supporting rod 2221 directly in the Z-axis direction by the driving body 2111, making the design of the projection device 1 more flexible.

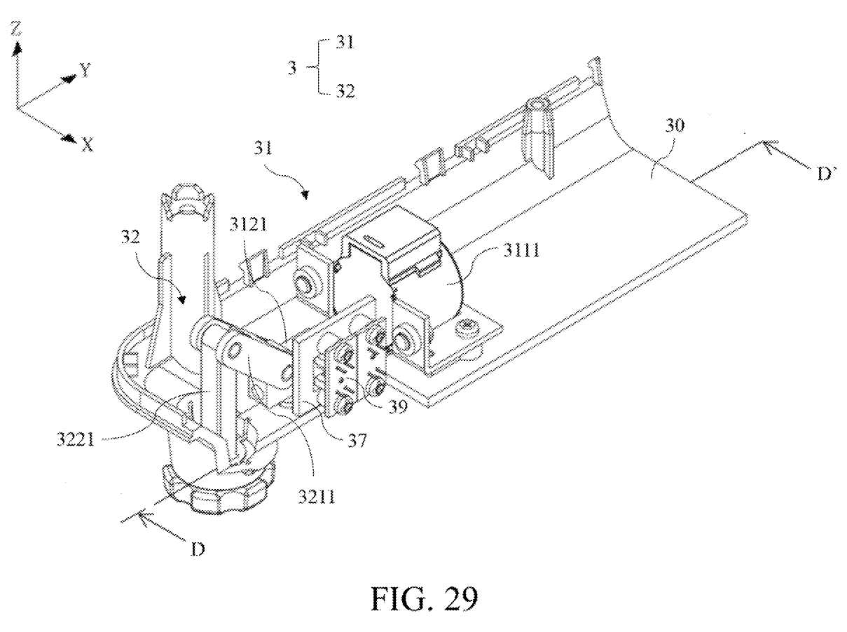

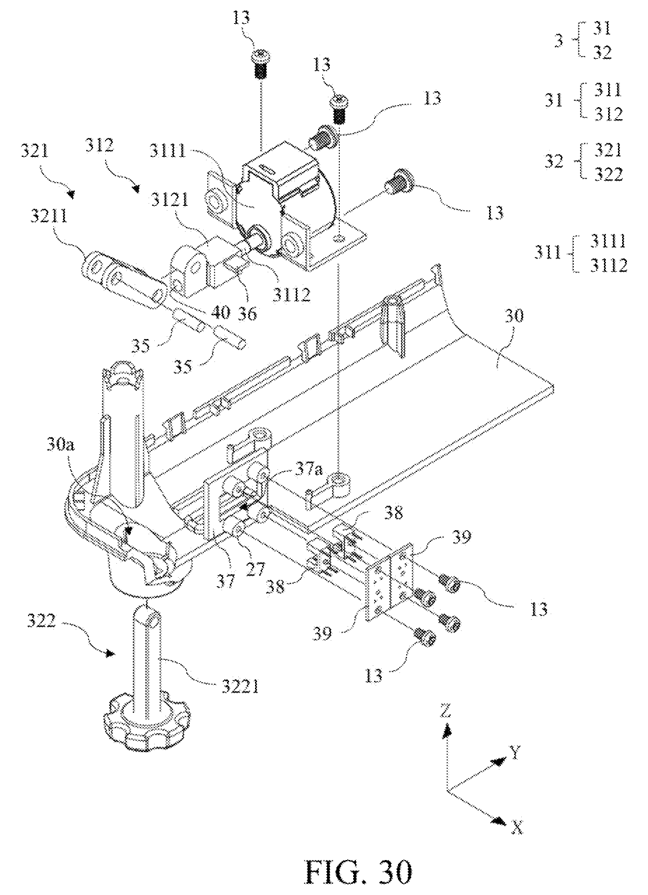

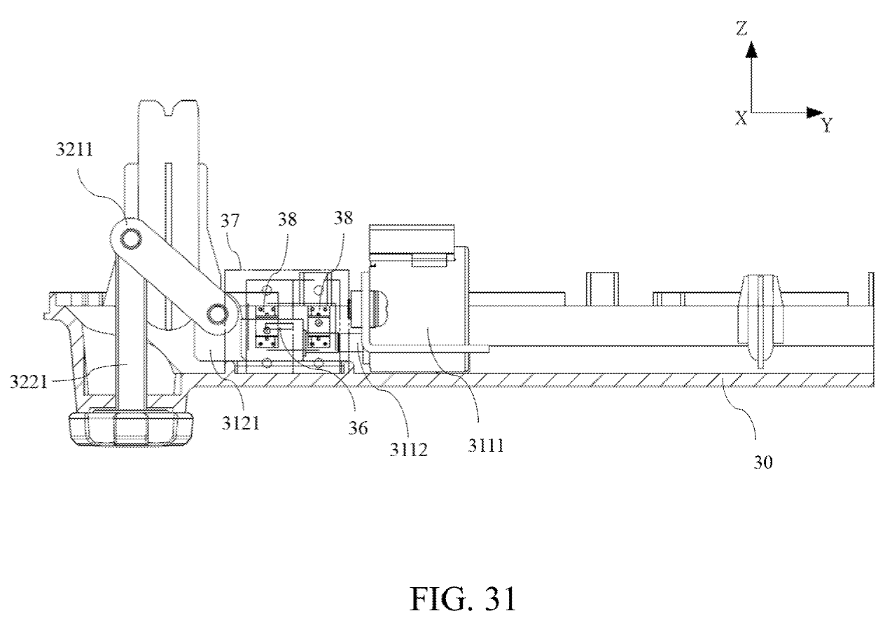

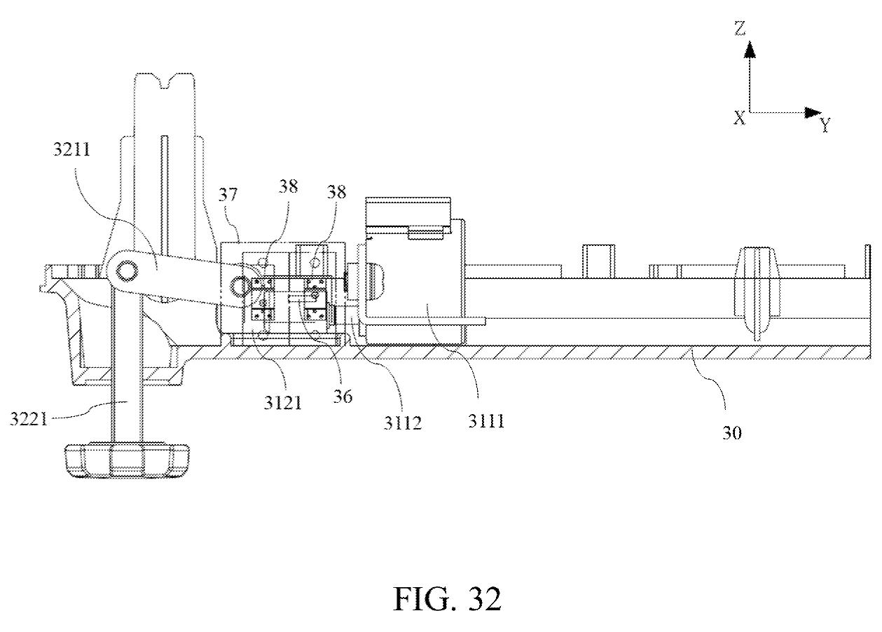

Please refer to FIGS. 29 to 32. FIG. 29 is a stereoscopic diagram of a seventh embodiment of an angle adjustment module of the present invention applied to a projection device, FIG. 30 is an exploded view of FIGS. 29, 31 is a cross-sectional diagram along line DD’ in FIGS. 29, and 32 is a schematic diagram of the elevating assembly of FIG. 31 moving toward the outside of the projection device. As shown in FIGS. 29 to 32, an angle adjustment module 3 comprises a driving device 31 and an elevating device 32. The driving device 31 is disposed in a projection device (not shown). The driving device 31 comprises a driving assembly 311 and a transmission assembly 312. The elevating device 32 comprises a linkage support assembly 321 and an elevating assembly 322. The driving assembly 311 is disposed on a bottom cover 30 of the projection device, and one end of the transmission assembly 312 is connected to the driving assembly 311. The elevating assembly 322 passes through an opening 30a of the bottom cover 30 and moves relative to the bottom cover 30 in a direction perpendicular to the bottom cover 30 (i.e., the Z-axis direction) to adjust a pitch angle of the projection device (as shown in FIGS. 31 and 32). The linkage support assembly 321 is disposed in the projection device, and the linkage support assembly 321 is respectively connected to one end of the elevating assembly 322 located in the projection device and the other end of the transmission assembly 312 to drive the elevating assembly 322 to move relative to the bottom cover 30, and provide a static support force for the elevating assembly 322. The static support force is a force that allows the elevating assembly 322 to maintain its current state when the driving assembly 311 does not drive the elevating assembly 322 to move.

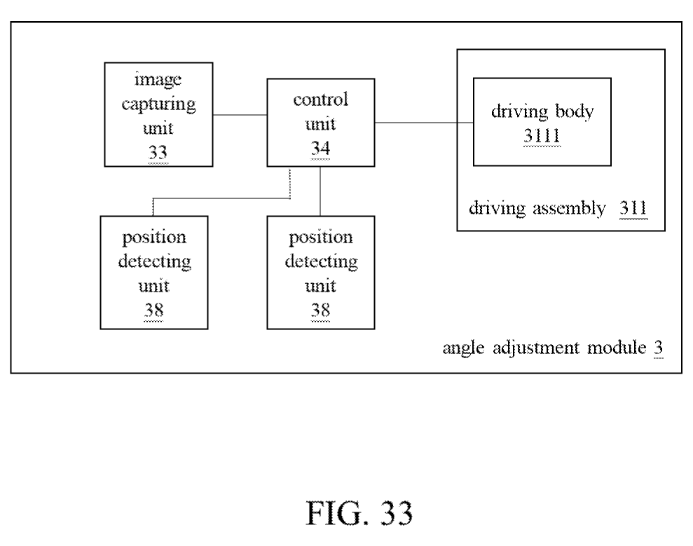

Please refer to FIG. 33, which is a circuit block diagram of the angle adjustment module of FIG. 29. As shown in FIG. 33, the angle adjustment module 3 may further comprise a control unit 34, which is connected to the driving assembly 311 and is disposed at any position in the projection device. In one embodiment, the angle adjustment module 3 may further comprise an image capturing unit 33, which is connected to the control unit 34. The image capturing unit 33 is configured to capture a captured image corresponding to a projection image of the projection device, and transmit the captured image to the control unit 34, so that the control unit 34 controls the driving assembly 311 based on the captured image, thereby adjusting the projection image. The control unit 34 may be, for example, a central processing unit, a microprocessor, a digital signal processor, a programmable controller, a programmable logic device or other similar devices or a combination thereof, but is not limited thereto. The control unit 34 may control the driving amount of the driving assembly 311 to adjust the movement of the elevating assembly 322 accordingly. The control unit 34 may further control the driving assembly 311 at any time based on the degree of distortion of the actual projection image in the captured image, thereby adjusting the movement of the elevating assembly 322 to meet the full-automatic real-time dynamic adjustment of the projection image of the projection device (i.e., automatic adjustment of the skewness of the projection image). It should be noted that in order to avoid over-complication of the drawings of FIGS. 29 to 32, the control unit 34 and its electrical connection relationship with any components in the projection device are only drawn in FIG. 33.

Please refer to FIGS. 29 to 32, the driving assembly 311 may comprise a driving body 3111 and a driving shaft 3112. The driving body 3111 is configured to drive the driving shaft 3112 to rotate, and the driving shaft 3112 is connected to the transmission assembly 312. Specifically, the driving body 3111 may be, but is not limited to, a driving motor, and the driving shaft 3112 may be, but is not limited to, a lead screw having an external thread, and the driving shaft 3112 is threadedly connected to the transmission assembly 312. The transmission assembly 312 may comprise a nut 3121, the nut 3121 may be provided with a hole 40, and the hole 40 is used for rotational engagement with the driving shaft 3112. Specifically, the hole 40 is provided with an internal thread, so that the hole 40 may be rotatably engaged with a lead screw serving as driving shaft 3112. The friction angle between the external thread of the lead screw and the internal thread of the hole 40 may result in a self-locking phenomenon, so that when the power supply to the driving body 3111 is stopped or the driving body 2111 stops operating, the nut 3121 is not pushed back to the position of FIG. 31.

The linkage support assembly 321 may comprise a connecting rod 3211, and two ends of the connecting rod 3211 are respectively pivotally connected to a supporting rod 3221 of the elevating assembly 322 and the nut 3121. When the driving body 3111 drives the nut 3121 to perform the translational movement in the direction parallel to the bottom cover 30 (i.e., the Y-axis direction) through the driving shaft 3112, the nut 3121 drives the supporting rod 3221 through the connecting rod 3211, so that the supporting rod 3221 moves in the direction perpendicular to the bottom cover 30 (i.e., the Z-axis direction). The two ends of the connecting rod 3211 are respectively pivotally connected to the supporting rod 3221 and the nut 3121 through the pin shafts 35. That is, the connecting rod 3211 and the supporting rod 3221 are pivotally connected through one pin shaft 35, and the connecting rod 3211 and the nut 3121 are pivotally connected through another pin shaft 35. For example, when the driving body 3111 drives the driving shaft 3112 to rotate counterclockwise, the driving shaft 3112 drives the nut 3121 to move along the positive Y-axis direction (that is, the angle adjustment module 3 operates from FIGS. 31 to 32), the nut 3121 pulls the connecting rod 3211, the connecting rod 3211 rotates counterclockwise and drives supporting rod 3221 to move along the negative Z-axis direction; when the driving body 3111 drives the driving shaft 3112 to rotate clockwise, the driving shaft 3112 drives the nut 3121 to move along the negative Y-axis direction (that is, the angle adjustment module 3 operates from FIGS. 32 to 31), the nut 3121 pushes the connecting rod 3211, the connecting rod 3211 rotates clockwise and drives the supporting rod 3221 to move along the positive Z-axis direction.

Due to the friction between the driving shaft 3112 and the nut 3121, when the driving force stops, the nut 3121 will automatically stop moving and remain in the current position. This self-locking phenomenon can prevent the nut 3121 and the connecting rod 3211 from moving accidentally.

In addition, please refer to FIGS. 29 to 33, the nut 3121 may have a baffle 36; the angle adjustment module 3 may further comprise a plurality of position detecting units 38 on a vertical plate 37 of the bottom cover 30, and the control unit 34 is electrically connected to the plurality of position detecting units 38. The plurality of position detecting units 38 are located on at least one side of the movement trajectory of the baffle 36 and are configured to detect a current position of the baffle 36, and transmit a detection result to the control unit 34, so that the control unit 34 controls the driving assembly 311/driving body 3111 based on the detection result. The vertical plate 37 may be provided with an opening 37a and be integrally formed with the bottom cover 30, but is not limited thereto. The angle adjustment module 3 may further comprise a plurality of circuit boards 39, a plurality of screws 13 and a plurality of spacer columns 27. The plurality of spacer columns 27 are disposed between the plurality of circuit boards 39 and the vertical plate 37. The plurality of position detecting units 38 are disposed on the plurality of circuit boards 39 and face the vertical plate 37, and the opening 37a exposes the plurality of position detecting units 38, so that the plurality of position detecting units 38 are located on at least one side of the movement trajectory of the baffle 36. The plurality of circuit boards 39, the plurality of spacer columns 27 and the vertical plate 37 are locked together by the plurality of screws 13, but this embodiment is not intended to limit the present invention.

In this embodiment, the control unit 34 may obtain the current position of the baffle 36 (i.e., the current position of the nut 3121) through the detection result, and control the driving assembly 311/driving body 3111 to stop operating when it is determined that the baffle 36 is located at the limit of the detection range formed by the plurality of position detecting units 38, so as to prevent the nut 3121 from exceeding the pre-designed working range and colliding with other components, thereby causing damage. The position detecting unit 38 may be, but is not limited to, an infrared detection unit, a laser ranging unit or an image capture unit. The number of the position detecting units 38 and the number of the circuit boards 39 may be, but is not limited to, two, the position detecting units 38 and the circuit boards 39 are arranged in one-to-one correspondence, and the number of the position detecting units 38 and the number of the circuit boards 39 may be adjusted according to actual needs. The larger the number of the position detecting units 38, the more accurate the current position of the baffle 36 (i.e., the current position of the nut 3121) obtained by the control unit 34 through the plurality of position detecting units 38.

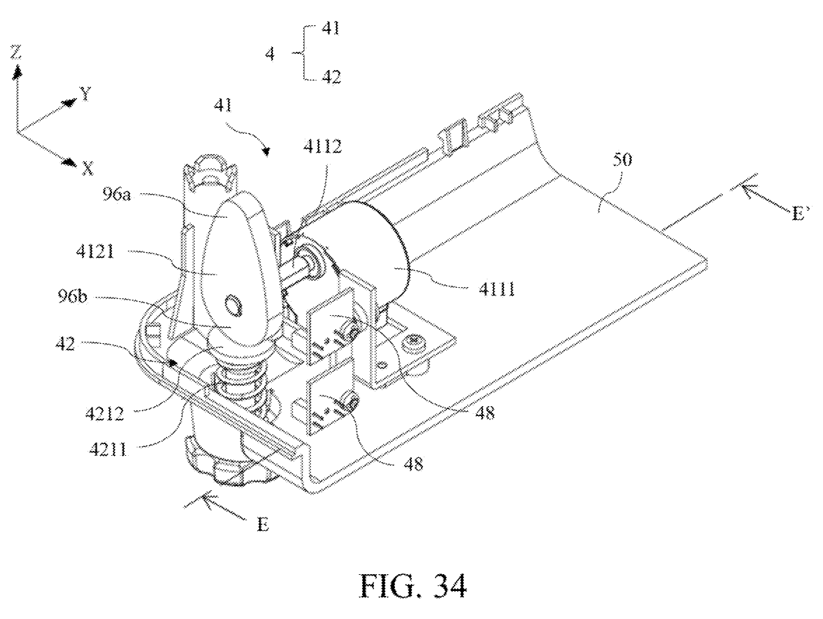

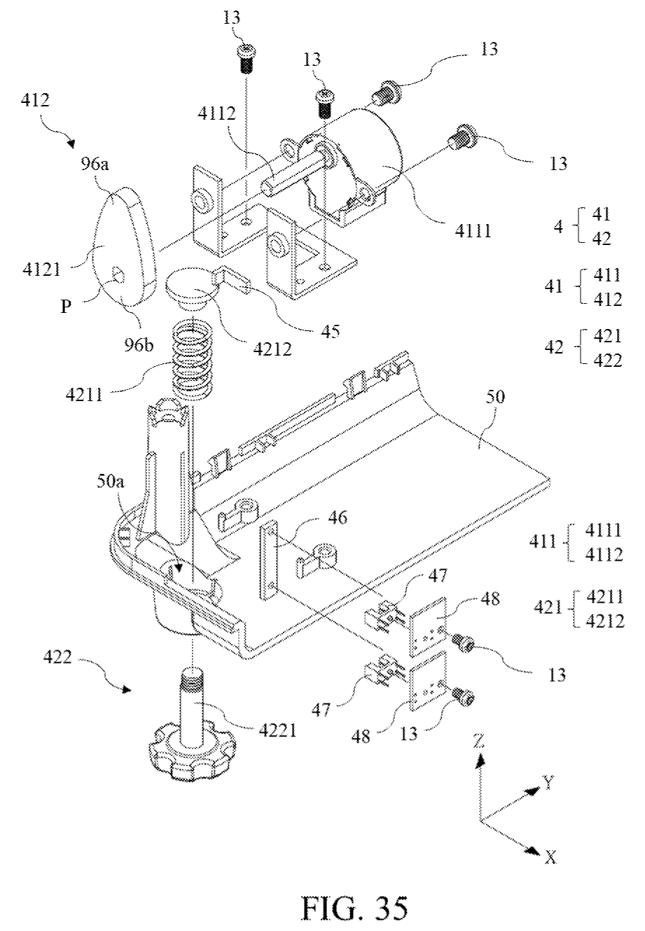

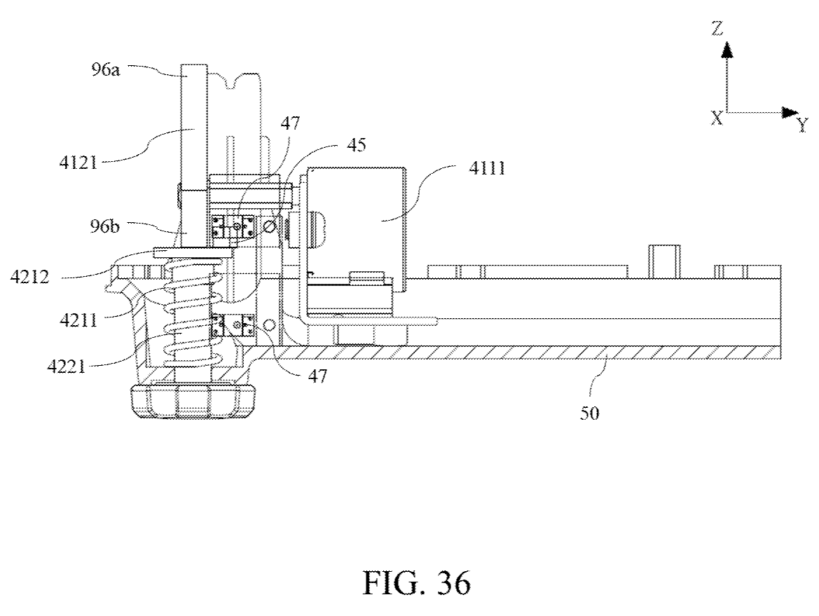

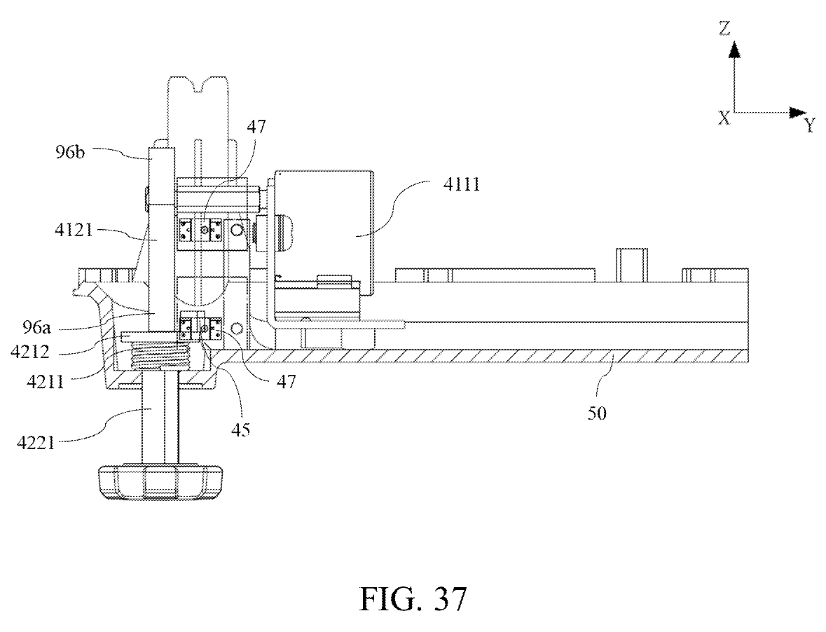

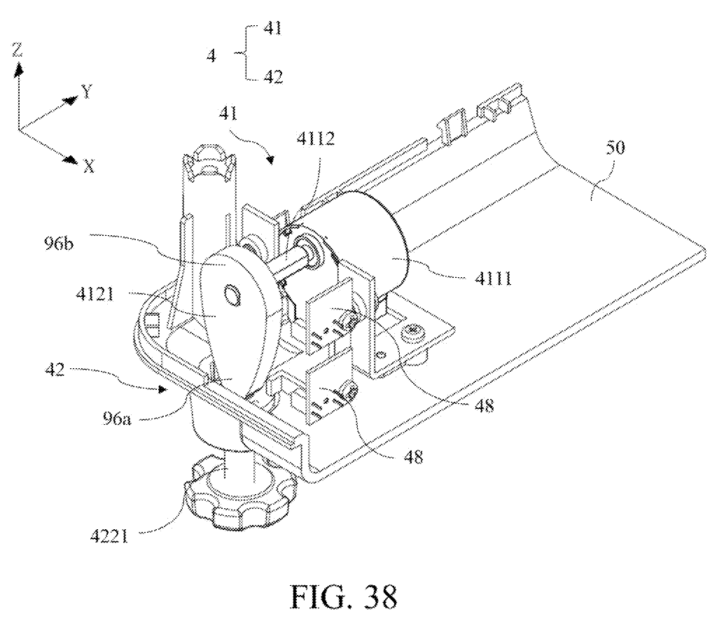

Please refer to FIGS. 34 to 38. FIG. 34 is a stereoscopic diagram of a eighth embodiment of an angle adjustment module of the present invention applied to a projection device, FIG. 35 is an exploded view of FIGS. 34, 36 is a cross-sectional diagram along line EE’ in FIGS. 34, 37 is a schematic diagram of the elevating assembly of FIG. 36 moving toward the outside of the projection device, and FIG. 38 is a stereoscopic schematic diagram of FIG. 37. As shown in FIGS. 34 to 38 , an angle adjustment module 4 comprises a driving device 41 and an elevating device 42, the driving device 41 is disposed in a projection device (not shown), the driving device 41 comprises a driving assembly 411 and a transmission assembly 412, and the elevating device 42 comprises a linkage support assembly 421 and an elevating assembly 422. The driving assembly 411 is disposed on a bottom cover 50 of the projection device, and one end of the transmission assembly 412 is connected to the driving assembly 411. The elevating assembly 422 passes through the opening 50a of the bottom cover 50 and moves relative to the bottom cover 50 in a direction perpendicular to the bottom cover 50 (i.e., the Z-axis direction) to adjust a pitch angle of the projection device (as shown in FIGS. 36 and 37). The linkage support assembly 421 is disposed in the projection device, and the linkage support assembly 421 is respectively connected to one end of the elevating assembly 422 located in the projection device and the other end of the transmission assembly 412 to drive the elevating assembly 422 to move relative to the bottom cover 50, and provide a static support force for the elevating assembly 422. The static support force is a force that allows the elevating assembly 422 to maintain its current state when the driving assembly 411 does not drive the elevating assembly 422 to move.

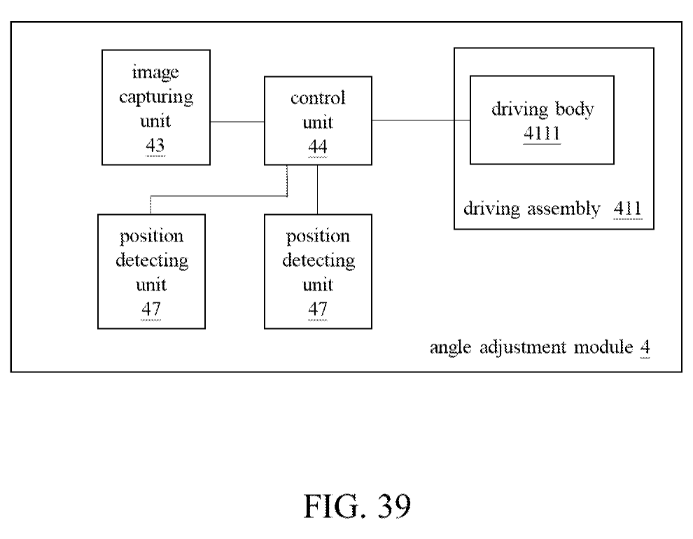

Please refer to FIG. 39, which is a circuit block diagram of the angle adjustment module of FIG. 34. As shown in FIG. 39, the angle adjustment module 4 may further comprise a control unit 44, which is connected to the driving assembly 411 and is disposed at any position in the projection device. In one embodiment, the angle adjustment module 4 may further comprise an image capturing unit 43, which is connected to the control unit 44. The image capturing unit 43 is configured to capture a captured image corresponding to a projection image of the projection device and transmit the captured image to the control unit 44, so that the control unit 44 controls the driving assembly 411 based on the captured image, thereby adjusting the projection image. The control unit 44 may be, for example, a central processing unit, a microprocessor, a digital signal processor, a programmable controller, a programmable logic device or other similar devices or a combination thereof, but is not limited thereto. The control unit 44 may control the driving amount of the driving assembly 411 to adjust the movement of the elevating assembly 422 accordingly. The control unit 44 may further control the driving assembly 411 at any time based on the degree of distortion of the actual projection image in the captured image, thereby adjusting the movement of the elevating assembly 422 to meet the full-automatic real-time dynamic adjustment of the projection image of the projection device (i.e., automatic adjustment of the skewness of the projection image). It should be noted that in order to avoid over-complication of the drawings of FIGS. 34 to 38, the control unit 44 and its electrical connection relationship with any components in the projection device are only drawn in FIG. 39.

Please refer to FIGS. 34 to 38, the driving assembly 411 may comprise a driving body 4111 and a driving shaft 4112. The driving body 4111 is configured to drive the driving shaft 4112 to rotate, and the driving shaft 4112 is connected to the transmission assembly 412. The driving body 4111 may be, but is not limited to, a driving motor. In addition, the transmission assembly 412 may comprise a cam 4121, a locking point P of the cam 4121 is locked to the driving shaft 4112, and the rotation of the driving shaft 4112 drives the rotation of the cam 4121, wherein the locking point P is located between the first end 96a and the second end 96b of the cam 4121, and a distance between the first end 96a and the locking point P is greater than a distance between the second end 96b and the locking point P. The linkage support assembly 421 may comprise an elastic element 4211 and a top plate 4212 connected to a supporting rod 4221 of the elevating assembly 422. The elastic element 4211 is sleeved on the supporting rod 4221 and two sides of the elastic element 4211 abut the top plate 4212 and the bottom cover 50 respectively. One end of the supporting rod 4221 may be screwed into the top plate 4212. When the driving body 4111 drives the cam 4121 to rotate through the driving shaft 4112, a first end 96a of the cam 4121 presses the top plate 4212 and compresses the elastic element 4211, or the second end 96b of the cam 4121 contacts the top plate 4212 and a restoring force of the elastic element 4211 pushes the top plate 4212, so that the supporting rod 4221 moves in the direction perpendicular to the bottom cover 50 (i.e., the Z-axis direction). The elastic element 4211 may provide the static support force for the elevating assembly 422.

Specifically, when the driving body 4111 drives the cam 4121 to rotate through the driving shaft 4112, and the first end 96a of the cam 4121 presses the top plate 4212 (i.e., the angle adjustment module 4 operates from FIGS. 34 to 38), the force of the first end 96a of the cam 4121 pressing the top plate 4212 is greater than the sum of the elastic force of the elastic element 4211 and the gravity of the projection device carried by the elevating assembly 422 , so that the cam 4121 drives the supporting rod 4221 to move along the negative Z-axis direction and compress the elastic element 4211. When the driving body 4111 drives the cam 4121 to rotate through the driving shaft 4112, and the second end 96b of the cam 4121 presses the top plate 4212 (that is, the angle adjustment module 4 operates from FIGS. 38 to 34), the restoring force of the elastic element 4211 pushes the top plate 4212, so that the elevating assembly 422 may move along the positive Z-axis direction. Therefore, by the arrangement of the elastic element 4211, the supporting rod 4221 may move in the direction perpendicular to the bottom cover 50 (i.e., the Z-axis direction), and at the same time, the static support force may be provided for the elevating assembly 422.

In addition, please refer to FIGS. 34 to 39, the top plate 4212 may have a baffle 45; the angle adjustment module 4 may further comprise a plurality of position detecting units 47 on a vertical plate 46 of the bottom cover 50, and the control unit 44 is connected to the plurality of position detecting units 47. The plurality of position detecting units 47 are located on at least one side of the movement trajectory of the baffle 45 and are configured to detect a current position of the baffle 45, and transmit a detection result to the control unit 44, so that the control unit 44 controls the driving assembly 411/driving body 4111 based on the detection result. The vertical plate 46 may be integrally formed with the bottom cover 50, but is not limited thereto. The angle adjustment module 4 may further comprise a plurality of circuit boards 48 and a plurality of screws 13. The plurality of position detecting units 47 are disposed on the plurality of circuit boards 48 and are located on at least one side of the movement trajectory of the baffle 45. The plurality of circuit boards 48 and the vertical plate 46 are locked together by the plurality of screws 13, but this embodiment is not intended to limit the present invention.

In this embodiment, the control unit 44 may obtain the current position of the baffle 45 (i.e., the current position of the top plate 4212) through the detection result, and control the driving assembly 411/driving body 4111 to stop operating when it is determined that the baffle 45 is located at the limit of the detection range formed by the plurality of position detecting units 47, so as to prevent the top plate 4212 from exceeding the pre-designed working range and colliding with other components, thereby causing damage. The position detecting unit 47 may be, but is not limited to, an infrared detection unit, a laser ranging unit or an image capture unit. The position detecting units 47 and the circuit boards 48 are arranged in one-to-one correspondence. The number of the position detecting units 47 and the number of the circuit boards 48 may be, but are not limited to, two. The number of position detecting units 47, the number of circuit boards 48, and the corresponding relationship between the position detecting units 47 and the circuit boards 48 may be adjusted according to actual needs. The larger the number of position detecting units 47, the more accurate the current position of the baffle 45 (i.e., the current position of the top plate 4212) obtained by the control unit 44 through the plurality of position detecting units 47.

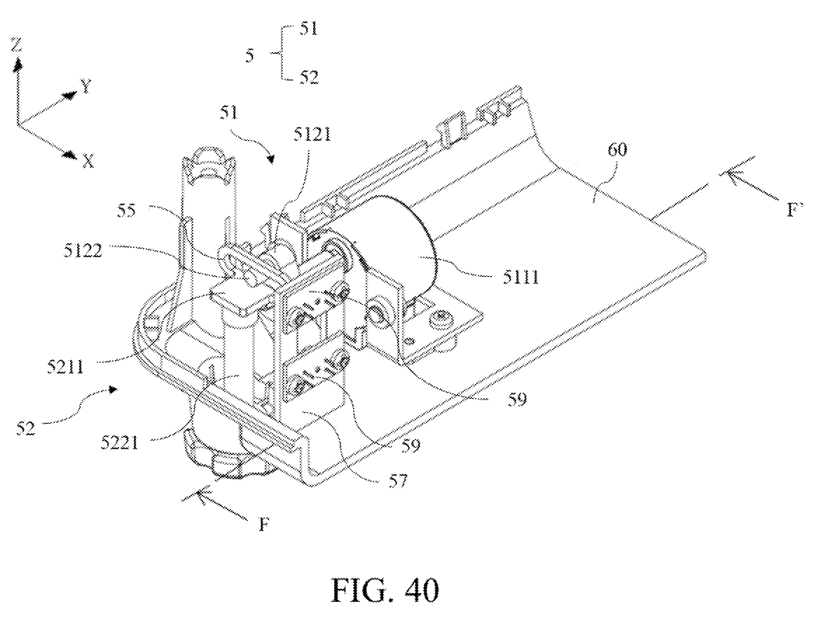

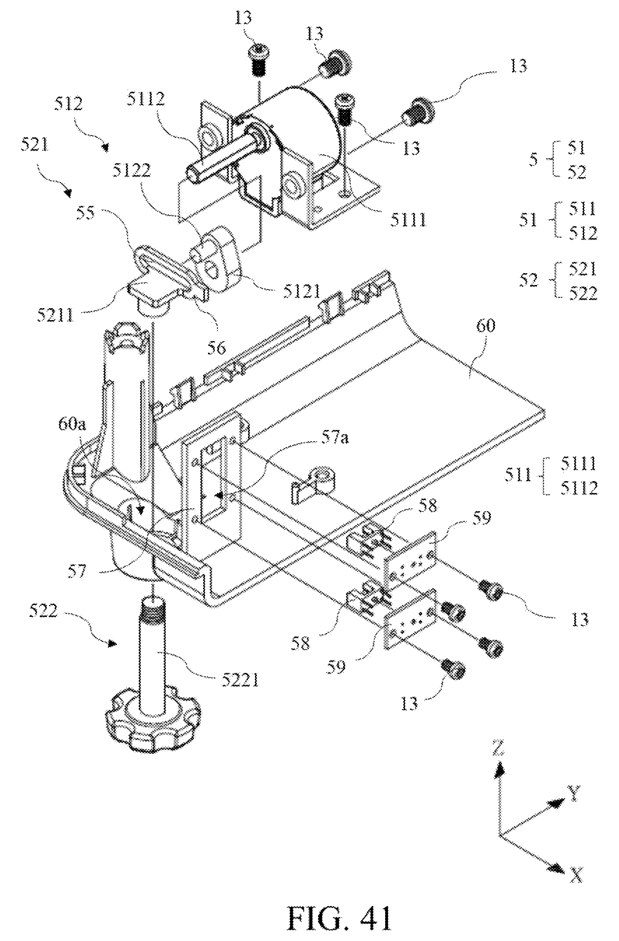

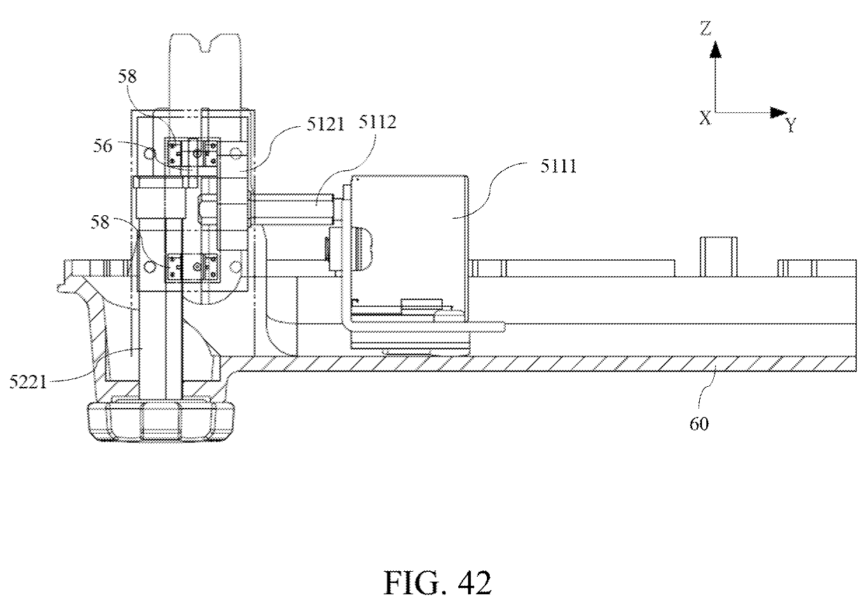

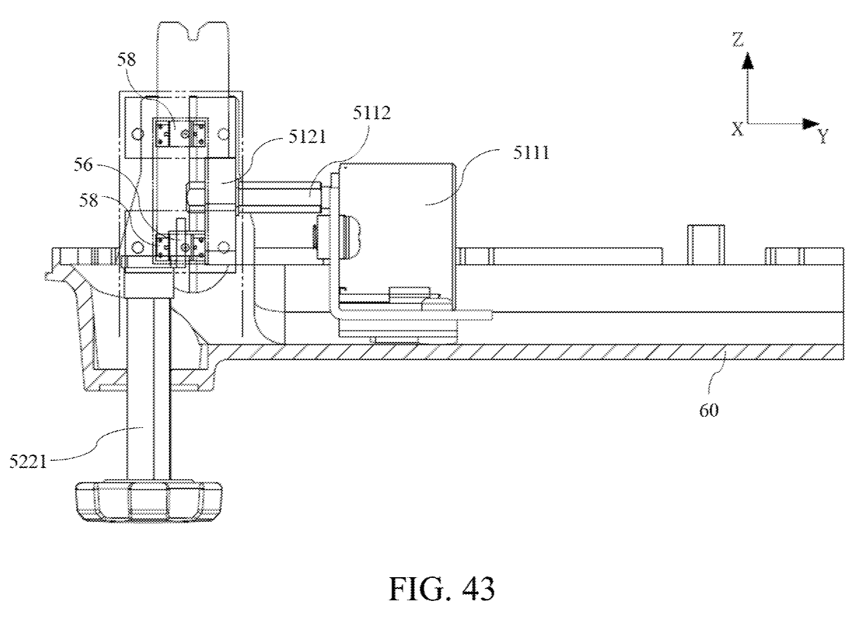

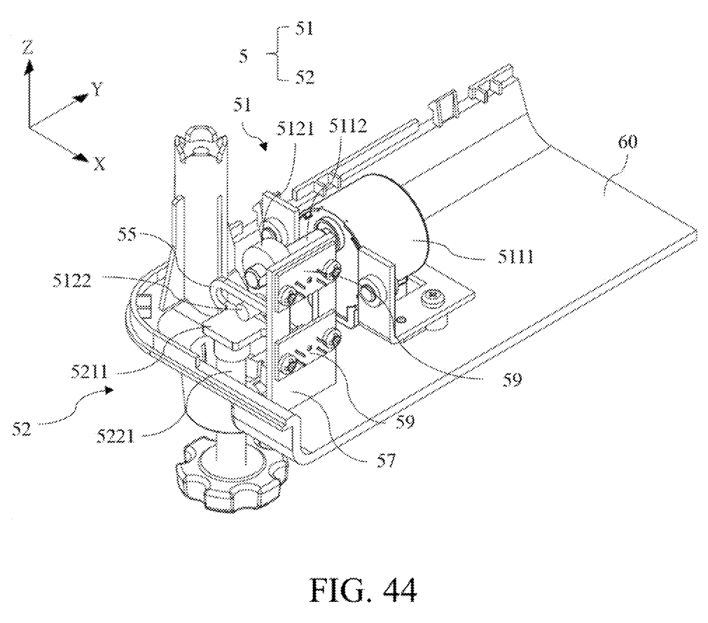

Please refer to FIGS. 40 to 44. FIG. 40 is a stereoscopic diagram of a ninth embodiment of an angle adjustment module of the present invention applied to a projection device, FIG. 41 is an exploded view of FIGS. 40, 42 is a cross-sectional diagram along line FF’ in FIGS. 40, 43, is a circuit block diagram of the elevating assembly of FIGS. 42, and 44 is a schematic diagram of the angle adjustment module of FIG. 43. As shown in FIGS. 40 to 44, an angle adjustment module 5 comprises a driving device 51 and an elevating device 52. The driving device 51 is disposed in a projection device (not shown). The driving device 51 comprises a driving assembly 511 and a transmission assembly 512. The elevating device 52 comprises a linkage support assembly 521 and an elevating assembly 522. The driving assembly 511 is disposed on a bottom cover 60 of the projection device, and one end of the transmission assembly 512 is connected to the driving assembly 511. The elevating assembly 522 passes through an opening 60a of the bottom cover 60 and moves relative to the bottom cover 60 in a direction perpendicular to the bottom cover 60 (i.e., the Z-axis direction) to adjust a pitch angle of the projection device (as shown in FIGS. 42 and 43). The linkage support assembly 521 is disposed in the projection device, and the linkage support assembly 521 is respectively connected to one end of the elevating assembly 522 located in the projection device and the other end of the transmission assembly 512 to drive the elevating assembly 522 to move relative to the bottom cover 60, and provide a static support force for the elevating assembly 522. The static support force is a force that allows the elevating assembly 522 to maintain its current state when the driving assembly 511 does not drive the elevating assembly 522 to move.

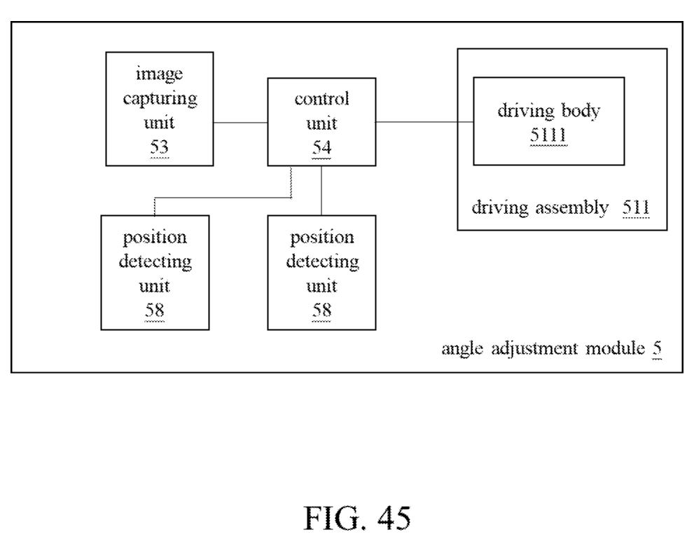

Please refer to FIG. 45, which is a circuit diagram of the angle adjustment module of FIG. 40. As shown in FIG. 45, the angle adjustment module 5 may further comprise a control unit 54, which is connected to the driving assembly 511 and is disposed at any position in the projection device. In one embodiment, the angle adjustment module 5 may further comprise an image capturing unit 53, which is connected to the control unit 54. The image capturing unit 53 is configured to capture a captured image corresponding to a projection image of the projection device, and transmit the captured image to the control unit 54, so that the control unit 54 controls the driving assembly 511 based on the captured image, thereby adjusting the projection image. The control unit 54 may be, for example, a central processing unit, a microprocessor, a digital signal processor, a programmable controller, a programmable logic device or other similar devices or a combination thereof, but is not limited thereto. The control unit 54 may control the driving amount of the driving assembly 511 to adjust the movement of the elevating assembly 522 accordingly. The control unit 54 may further control the driving assembly 511 at any time based on the degree of distortion of the actual projection image in the captured image, thereby adjusting the movement of the elevating assembly 522 to meet the full-automatic real-time dynamic adjustment of the projection image of the projection device (i.e., automatic adjustment of the skewness of the projection image). It should be noted that in order to avoid over-complication of the drawings of FIGS. 40 to 44, the control unit 54 and its electrical connection relationship with any components in the projection device are only drawn in FIG. 45.

Please refer to FIGS. 40 to 44, the driving assembly 511 may comprise a driving body 5111 and a driving shaft 5112. The driving body 5111 is configured to drive the driving shaft 5112 to rotate. The driving shaft 5112 is connected to the transmission assembly 512. The driving body 5111 may be, but is not limited to, a driving motor. In addition, the transmission assembly 512 may comprise a cam 5121 and a pillar 5122, one end of the cam 5121 is locked to the driving shaft 5112, the pillar 5122 is arranged at the other end of the cam 5121 (that is, the pillar 5122 is an eccentric protrusion of the cam 5121), and the driving shaft 5112 is configured to drive the cam 5121 to rotate. The linkage support assembly 521 comprises a driving plate 5211 connected to the supporting rod 5221 of the elevating assembly 522. The driving plate 5211 is provided with a horizontal guide slot 55, the pillar 5122 is slidably matched with the horizontal guide slot 55, the pillar 5122 is configured to slide in the horizontal guide slot 55, and one end of the supporting rod 5221 may be screwed into the driving plate 5211. When the driving body 5111 drives the cam 5121 to rotate through the driving shaft 5112, the pillar 5122 slides relatively along the horizontal guide slot 55, so that the supporting rod 5221 moves in the direction perpendicular to the bottom cover 60.

Specifically, when the driving body 5111 drives the cam 5121 to rotate clockwise through the driving shaft 5112, the pillar 5122 slides relatively along the horizontal guide slot 55 due to the rotation of the cam 5121 (that is, the angle adjustment module 5 operates from FIGS. 40 to 44). The force of the pillar 5122 pressing the driving plate 5211 due to the clockwise rotation of the cam 5121 is greater than the gravity of the projection device carried by the elevating assembly 522, so that the cam 5121 drives the supporting rod 5221 to move along the negative Z-axis direction. When the driving body 5111 drives the cam 5121 to rotate counterclockwise through the driving shaft 5112, the pillar5122 slides relatively along the horizontal guide slot 55 due to the rotation of the cam 5121 (that is, the angle adjustment module 5 operates from FIGS. 44 to 40). The counterclockwise rotation of the cam 5121 drives the pillar 5122 to pull the driving plate 5211 to move along the positive Z-axis direction, so that the supporting rod 5221 of the elevating assembly 522 may move along the positive Z-axis direction.

In addition, please refer to FIGS. 40 to 45, the driving plate 5211 may have a baffle 56; the angle adjustment module 5 may further comprise a plurality of position detecting units 58 on a vertical plate 57 of the bottom cover 60, and the control unit 54 is connected to the plurality of position detecting units 58. The plurality of position detecting units 58 are located on at least one side of the movement trajectory of the baffle 56 and are configured to detect a current position of the baffle 56, and transmit a detection result to the control unit 54, so that the control unit 54 controls the driving assembly 511/driving body 5111 based on the detection result. The vertical plate 57 may be provided with an opening 57a and may be integrally formed with the bottom cover 60, but is not limited thereto. The angle adjustment module 5 may further comprise a plurality of circuit boards 59 and a plurality of screws 13. The plurality of circuit boards 59 and the vertical plate 57 are locked together by the plurality of screws 13. The plurality of position detecting units 58 are disposed on the plurality of circuit boards 59, and the opening 57a exposes the plurality of position detecting units 58, so that the plurality of position detecting units 58 are located on at least one side of the movement trajectory of the baffle 56, but this embodiment is not used to limit the present invention.

In this embodiment, the control unit 54 may obtain the current position of the baffle 56 (i.e., the current position of the driving plate 5211) through the detection result, and control the driving assembly 511/driving body 5111 to stop operating when it is determined that the baffle 56 is located at the limit of the detection range formed by the plurality of position detecting units 58, so as to prevent the driving plate 5211 from exceeding the pre-designed working range and colliding with other components, thereby causing damage. The position detecting unit 58 may be, but is not limited to, an infrared detection unit, a laser ranging unit or an image capture unit. The position detecting units 58 and the circuit boards 59 are arranged in one-to-one correspondence, the number of position detecting units 58 and the number of circuit boards 59 may be, but are not limited to, two, and the number of position detecting units 58, the number of circuit boards 59 and the corresponding relationship between the position detecting units 58 and the circuit boards 59 may be adjusted according to actual needs. The larger the number of position detecting units 58, the more accurate the current position of the baffle 56 (i.e., the current position of the driving plate 5211) obtained by the control unit 54 through the plurality of position detecting units 58.

In summary, the angle adjustment module and the projection device of the embodiments of the present invention have at least one of the following advantages: the transmission assembly is driven by the driving assembly, so that the transmission assembly drives the linkage support assembly to move, and then drives the elevating assembly to move relative to the bottom cover, which can improve the inconvenience of the existing projection device in adjusting the pitch angle. The movement of the elevating assembly is adjusted according to the driving amount of the driving assembly, which is a stepless adjustment and can more accurately control the height of the elevating assembly extending out of the projection device, thereby improving the problem of poor adjustment efficiency in the pitch angle of the existing projection device. The linkage support assembly is connected to one end of the elevating assembly located in the projection device, so that the elevating assembly does not detach from the bottom of the projection device. By the horizontal placement design of the driving device, the height required for driving the supporting rod of the elevating assembly directly in a thickness direction of the projection device by the driving body is eliminated, making the design of the projection device more flexible. By the arrangements of the position detecting units, the transmission assembly and the linkage support assembly are prevented from exceeding the pre-designed working range and colliding with other components, thereby causing damage. By the arrangements of the image capturing unit and the control unit, the projection device may achieve full-automatic real-time dynamic adjustment of the projection image. The projection device is designed with a plurality of angle adjustment modules to meet the needs of skewed projection image correction in different directions. Due to the self-locking phenomenon between the driving assembly and the transmission assembly, the transmission assembly and the driving assembly of the projection device will not be pushed back to their original positions (i.e., the configuration positions of the transmission assembly and the linkage support assembly when the supporting rod of the elevating assembly does not move toward the outside of the projection device) when the power supply to the driving assembly is stopped or the driving assembly stops operating.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby enabling persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An angle adjustment module of a projection device comprising a bottom cover with an opening, wherein the angle adjustment module comprises:
a driving device disposed in the projection device and comprising a driving assembly and a transmission assembly, wherein the driving assembly is disposed on the bottom cover, and one end of the transmission assembly is connected to the driving assembly; and
an elevating device comprising a linkage support assembly and an elevating assembly, wherein the elevating assembly passes through the opening of the bottom cover and moves relative to the bottom cover in a direction perpendicular to the bottom cover to adjust an pitch angle of the projection device, the linkage support assembly is disposed in the projection device, and the linkage support assembly is respectively connected to one end of the elevating assembly located in the projection device and the other end of the transmission assembly to drive the elevating assembly to move relative to the bottom cover and provide a static support force for the elevating assembly.

2. The angle adjustment module according to claim 1, wherein the driving assembly comprises a driving body and a driving shaft, the driving body is configured to drive the driving shaft to rotate, and the driving shaft is connected to the transmission assembly.

3. The angle adjustment module according to claim 2, wherein the transmission assembly comprises a wedge-shaped nut, the wedge-shaped nut is provided with a hole, the hole is configured to rotatably engage with the driving shaft; the angle adjustment module further comprises a fixing plate, the fixing plate is fixed on a plurality of fixing columns of the bottom cover, the plurality of fixing columns are disposed around a supporting protrusion, the supporting protrusion is comprised in the bottom cover for supporting the wedge-shaped nut, and the fixing plate, the supporting protrusion of the bottom cover and the plurality of fixing columns enable the wedge-shaped nut to perform a translational movement in a direction parallel to the bottom cover; the linkage support assembly comprises a wedge block, the elevating assembly comprises a supporting rod locked to the wedge block; a first inclined surface of the wedge block is parallel to a second inclined surface of the wedge-shaped nut; when the driving body drives the wedge-shaped nut to perform the translational movement in the direction parallel to the bottom cover through the driving shaft, the wedge-shaped nut pushes the wedge block through the second inclined surface to move the supporting rod in the direction perpendicular to the bottom cover.

4. The angle adjustment module according to claim 3, wherein the linkage support assembly further comprises an elastic element, the elastic element is sleeved on the supporting rod and two sides of the elastic element abut the wedge block and the bottom cover respectively; when the wedge-shaped nut performs translational movement in the direction parallel to the bottom cover, the wedge-shaped nut compresses the elastic element by pushing the wedge block, or the wedge block is pushed by a restoring force of the elastic element; the elastic element is configured to provide the static support force for the elevating assembly.

5. The angle adjustment module according to claim 4, wherein the first inclined surface of the wedge block is provided with a groove, the second inclined surface of the wedge-shaped nut is provided with a rib, configuration positions of the groove and the rib correspond to each other; when the wedge-shaped nut pushes the wedge block through the second inclined surface, the rib slides in the groove, so that the wedge-shaped nut pushes the wedge block.

6. The angle adjustment module according to claim 3, wherein the linkage support assembly further comprises a fastening nut, and one end of the supporting rod passes through the wedge block and is screwed into the fastening nut.

7. The angle adjustment module according to claim 3, wherein the fixing plate has a linear slot, a top portion of the wedge-shaped nut has a baffle; when the wedge-shaped nut performs the translational movement in the direction parallel to the bottom cover, the baffle moves along the linear slot; the angle adjustment module further comprises a plurality of position detecting units on the fixing plate and a control unit connected to the plurality of position detecting units; the plurality of position detecting units are located on at least one side of a movement trajectory of the baffle and are configured to detect a current position of the baffle, and transmit a detection result to the control unit, so that the control unit controls the driving assembly based on the detection result.

8. The angle adjustment module according to claim 3, wherein the second inclined surface is provided with a guide groove, the first inclined surface is provided with a tooth, the tooth includes a main tooth standing on the first inclined surface and a secondary tooth extending from a top end of the main tooth; when the wedge-shaped nut performs the translational movement in the direction parallel to the bottom cover, the main tooth slides relatively along the guide groove, and an orthographic projection of the secondary tooth on the second inclined surface at least partially overlaps an area outside the guide groove on the second inclined surface; the linkage support assembly provides the static support force for the elevating assembly through the secondary tooth.

9. The angle adjustment module according to claim 8, wherein the main tooth and the secondary tooth form a T-shaped tooth.

10. The angle adjustment module according to claim 2, wherein the transmission assembly comprises a nut, the nut is provided with a hole for rotational engagement with the driving shaft; the linkage support assembly comprises a connecting rod, two ends of the connecting rod are respectively pivotally connected to a supporting rod of the elevating assembly and the nut; when the driving body drives the nut to perform a translational movement in a direction parallel to the bottom cover through the driving shaft, the nut drives the supporting rod through the connecting rod, so that the supporting rod moves in the direction perpendicular to the bottom cover.

11. The angle adjustment module according to claim 10, wherein the nut has a baffle; the angle adjustment module further comprises a plurality of position detecting units on a vertical plate of the bottom cover and a control unit connected to the plurality of position detecting units; the plurality of position detecting units are located on at least one side of a movement trajectory of the baffle and are configured to detect a current position of the baffle, and transmit a detection result to the control unit, so that the control unit controls the driving assembly based on the detection result.

12. The angle adjustment module according to claim 2, wherein the transmission assembly comprises a cam, a locking point of the cam is locked to the driving shaft, and rotation of the driving shaft drives rotation of the cam; the linkage support assembly comprises an elastic element and a top plate connected to a supporting rod of the elevating assembly, the elastic element is sleeved on the supporting rod and two sides of the elastic element abut the top plate and the bottom cover respectively; when the driving body drives the cam to rotate through the driving shaft, a first end of the cam presses the top plate and compresses the elastic element, or a second end of the cam contacts the top plate and a restoring force of the elastic element pushes the top plate, so that the supporting rod moves in the direction perpendicular to the bottom cover, the locking point is located between the first end and the second end, and a distance between the first end and the locking point is greater than a distance between the second end and the locking point; the elastic element is configured to provide the static support force for the elevating assembly.

13. The angle adjustment module according to claim 2, wherein the transmission assembly comprises a cam and a pillar, one end of the cam is locked to the driving shaft, the pillar is arranged at the other end of the cam, and the driving shaft is configured to drive the cam to rotate; the linkage support assembly comprises a driving plate connected to a supporting rod of the elevating assembly, the driving plate is provided with a horizontal guide slot, and the pillar is configured to slide in the horizontal guide slot; when the driving body drives the cam to rotate through the driving shaft, the pillar slides relatively along the horizontal guide slot, so that the supporting rod moves in the direction perpendicular to the bottom cover.

14. The angle adjustment module according to claim 1, wherein one side of the linkage support assembly has a baffle; the angle adjustment module further comprises a plurality of position detecting units on a vertical plate of the bottom cover and a control unit connected to the plurality of position detecting units; the plurality of position detecting units are located on at least one side of a movement trajectory of the baffle and are configured to detect a current position of the baffle, and transmit a detection result to the control unit, so that the control unit controls the driving assembly based on the detection result.

15. The angle adjustment module according to claim 1, further comprising an image capturing unit and a control unit, wherein the image capturing unit is connected to the control unit, and the control unit is connected to the driving assembly; the image capturing unit is configured to capture a captured image corresponding to a projection image of the projection device, and transmit the captured image to the control unit, so that the control unit controls the driving assembly based on the captured image, thereby adjusting the projection image.

16. A projection device, comprising:
a bottom cover provided with an opening; and
an angle adjustment module comprising:
a driving device disposed in the projection device, wherein the driving device comprises a driving assembly and a transmission assembly, the driving assembly is mounted on the bottom cover, and one end of the transmission assembly is connected to the driving assembly; and
an elevating device comprising a linkage support assembly and an elevating assembly, wherein the elevating assembly passes through the opening and moves relative to the projection device in a direction perpendicular to the bottom cover to adjust a pitch angle of the projection device; the linkage support assembly is disposed in the projection device, the linkage support assembly is connected to one end of the elevating assembly located in the projection device and the other end of the transmission assembly respectively to drive the elevating assembly to move relative to the bottom cover and provide a static support force for the elevating assembly.

17. The projection device according to claim 16, wherein the driving assembly comprises a driving body and a driving shaft, the driving body is configured to drive the driving shaft to rotate, and the driving shaft is connected to the transmission assembly.

18. The projection device according to claim 17, wherein the transmission assembly comprises a wedge-shaped nut, the wedge-shaped nut is provided with a hole, the hole is configured to rotatably engage with the driving shaft; the bottom cover is further provided with a supporting protrusion for supporting the wedge-shaped nut and a plurality of fixing columns around the supporting protrusion, the angle adjustment module further comprises a fixing plate fixed on the plurality of fixing columns, and the fixing plate, the supporting protrusion of the bottom cover and the plurality of fixing columns enable the wedge-shaped nut to perform a translational movement in a direction parallel to the bottom cover; the linkage support assembly comprises a wedge block, the elevating assembly comprises a supporting rod locked to the wedge block; a first inclined surface of the wedge block is parallel to a second inclined surface of the wedge-shaped nut; when the driving body drives the wedge-shaped nut to perform the translational movement in the direction parallel to the bottom cover through the driving shaft, the wedge-shaped nut pushes the wedge block through the second inclined surface to move the supporting rod in the direction perpendicular to the bottom cover.

19. The projection device according to claim 18, wherein the linkage support assembly further comprises an elastic element, the elastic element is sleeved on the supporting rod and two sides of the elastic element abut the wedge block and the bottom cover respectively; when the wedge-shaped nut performs the translational movement in the direction parallel to the bottom cover, the wedge-shaped nut compresses the elastic element by pushing the wedge block, or the wedge block is pushed by a restoring force of the elastic element; the elastic element is configured to provide the static support force for the elevating assembly.

20. The projection device according to claim 19, wherein the first inclined surface is provided with a groove, the second inclined surface is provided with a rib, configuration positions of the groove and the rib correspond to each other; when the wedge-shaped nut pushes the wedge block through the second inclined surface, the rib slides in the groove, so that the wedge-shaped nut pushes the wedge block.

21. The projection device according to claim 18, wherein the second inclined surface is provided with a guide groove, the first inclined surface is provided with a tooth, the tooth comprises a main tooth standing on the first inclined surface and a secondary tooth extending from a top end of the main tooth; when the wedge-shaped nut performs the translational movement in the direction parallel to the bottom cover, the main tooth slides relatively along the guide groove, and an orthographic projection of the secondary tooth on the second inclined surface at least partially overlaps an area outside the guide groove on the second inclined surface; the linkage support assembly provides the static support force for the elevating assembly through the secondary tooth.

22. The projection device according to claim 18, wherein the linkage support assembly further comprises a fastening nut, and one end of the supporting rod passes through the wedge block and is screwed into the fastening nut.

23. The projection device according to claim 18, wherein the fixing plate has a linear slot, a top portion of the wedge-shaped nut has a baffle; when the wedge-shaped nut performs the translational movement in the direction parallel to the bottom cover, the baffle moves along the linear slot; the angle adjustment module further comprises a plurality of position detecting units on the fixing plate and a control unit connected to the plurality of position detecting units; the plurality of position detecting units are located on at least one side of a movement trajectory of the baffle and are configured to detect a current position of the baffle, and transmit a detection result to the control unit, so that the control unit controls the driving assembly based on the detection result.

24. The projection device according to claim 17, wherein the transmission assembly comprises a nut, the nut is provided with a hole for rotational engagement with the driving shaft; the linkage support assembly comprises a connecting rod, two ends of the connecting rod are respectively pivotally connected to a supporting rod of the elevating assembly and the nut; when the driving body drives the nut to perform a translational movement in a direction parallel to the bottom cover through the driving shaft, the nut drives the supporting rod through the connecting rod, so that the supporting rod moves in the direction perpendicular to the bottom cover.

25. The projection device according to claim 24, wherein the nut has a baffle; the angle adjustment module further comprises a plurality of position detecting units on a vertical plate of the bottom cover and a control unit connected to the plurality of position detecting units; the plurality of position detecting units are located on at least one side of a movement trajectory of the baffle and are configured to detect a current position of the baffle, and transmit a detection result to the control unit, so that the control unit controls the driving assembly based on the detection result.

26. The projection device according to claim 17, wherein the transmission assembly comprises a cam, a locking point of the cam is locked to the driving shaft, and rotation of the driving shaft drives rotation of the cam; the linkage support assembly comprises an elastic element and a top plate connected to a supporting rod of the elevating assembly, the elastic element is sleeved on the supporting rod and two sides of the elastic element abut the top plate and the bottom cover respectively; when the driving body drives the cam to rotate through the driving shaft, a first end of the cam presses the top plate and compresses the elastic element, or a second end of the cam contacts the top plate and a restoring force of the elastic element pushes the top plate, so that the supporting rod moves in the direction perpendicular to the bottom cover, the locking point is located between the first end and the second end, and a distance between the first end and the locking point is greater than a distance between the second end and the locking point; the elastic element is configured to provide the static support force for the elevating assembly.

27. The projection device according to claim 17, wherein the transmission assembly comprises a cam and a pillar, one end of the cam is locked to the driving shaft, the pillar is arranged at the other end of the cam, and rotation of the driving shaft drives rotation of the cam; the linkage support assembly comprises a driving plate connected to a supporting rod of the elevating assembly, the driving plate is provided with a horizontal guide slot, and the pillar is configured to slide in the horizontal guide slot; when the driving body drives the cam to rotate through the driving shaft, the pillar slides relatively along the horizontal guide slot, so that the supporting rod moves in the direction perpendicular to the bottom cover.

28. The projection device according to claim 16, wherein one side of the linkage support assembly has a baffle; the angle adjustment module further comprises a plurality of position detecting units on a vertical plate of the bottom cover and a control unit connected to the plurality of position detecting units; the plurality of position detecting units are located on at least one side of a movement trajectory of the baffle and are configured to detect a current position of the baffle, and transmit a detection result to the control unit, so that the control unit controls the driving assembly based on the detection result.

29. The projection device according to claim 16, wherein the angle adjustment module further comprises an image capturing unit and a control unit, the image capturing unit is connected to the control unit, and the control unit is connected to the driving assembly; the image capturing unit is configured to capture a captured image corresponding to a projection image of the projection device, and transmit the captured image to the control unit, so that the control unit controls the driving assembly based on the captured image, thereby adjusting the projection image.
